(19) United States
(12) Patent Application Publication
(10) Pub. No.: US 2026/0087394 A1
(43) Pub. Date: Mar. 26, 2026

(54) Parallel Readout of Qubits with an Optical Cavity

(71) Applicant: Massachusetts Institute of Technology, Cambridge, MA (US)

(72) Inventors: Matthew Peters, Boulder, CO (US); Ziv Aqua, Cambridge, MA (US); David Spierings van der Wolk, Newton, MA (US); Guoqing Wang, Cambridge, MA (US); Edita Bytyqi, Cambridge, MA (US); Thomas Propson, Cambridge, MA (US); Vladan Vuletic, Cambridge, MA (US)

(21) Appl. No.: 19/337,988

(22) Filed: Sep. 24, 2025

Related U.S. Application Data
(60) Provisional application No. 63/698,240, filed on Sep. 24, 2024.

(51) Int. Cl. G06N 10/40

(52) U.S. Cl. CPC G06N 10/40

(57) ABSTRACT

Qubit arrays, such as neutral atom arrays and ion arrays, provide versatile platforms for quantum information processing. However, in large-scale arrays, efficient photon collection remains a bottleneck for fast, non-destructive qubit readout and remote entanglement distribution. Our cavity-based approach enables fast, parallel operations over many qubits using multiple modes of a single optical cavity. By selectively shifting the relevant atomic transitions, each qubit can be coupled to a distinct cavity mode, allowing independent simultaneous processing. Practical systems support cavity-mode multiplexing with large numbers of modes, enabling rapid mid-circuit syndrome extraction and significantly enhancing entanglement distribution rate between remote atom arrays. Our technology provides a scalable solution to core challenges in qubit arrays, advancing the development of practical quantum technologies.

### CROSS-REFERENCE TO RELATED APPLICATION(S)

This application claims the priority benefit, under 35 U.S.C. 119 (e), of U.S. Application No. 63/698,240, filed on Sep. 24, 2024, which is incorporated herein by reference in its entirety for all purposes.

### GOVERNMENT SUPPORT

This invention was made with government support under DE-AC02-05CH11231 awarded by the U.S. Department of Energy. The government has certain rights in the invention.

### BACKGROUND

Neutral atom arrays are a leading platform for fault-tolerant quantum computing, offering high-fidelity single- and two-qubit gates with arbitrary connectivity enabled by coherent transport of qubits. These capabilities support fault-tolerant logical operations in small quantum error correction (QEC) codes. At the same time, systems with increasingly large array sizes have been realized, including recent demonstrations of continuous operation with up to 3000 atoms. Despite these advances, utility-level quantum processors are expected to require millions of qubits operating under high-rate QEC cycles.

Progress toward this regime can be advanced by improving two essential hardware-level operations: (i) non-destructive qubit readout for mid-circuit measurements (MCM), enabling entropy removal in QEC codes, and (ii) remote entanglement distribution, enabling scalability through a network of interconnected quantum processing modules. Both operations depend on collecting photons scattered by individual atoms in the array. In current systems, this is typically implemented using high numerical-aperture microscope objectives, but their limited collection efficiency (e.g., about 10%) restricts performance. Consequently, non-destructive readout and remote entanglement generation are generally limited to timescales of several milliseconds, introducing a bottleneck for QEC cycle rates and hindering the feasibility of modular scale-up.

Optical cavities provide a promising solution by enhancing atomic emission into a well-defined mode via the Purcell effect, enabling both high photon collection efficiencies and strong light-matter interactions that support fast, cavity-mediated operations. A figure of merit in this context is the cooperativity, denoted by η, a dimensionless parameter characterizing the strength of the atom-cavity interaction. Recent experiments have demonstrated fast, high-fidelity, non-destructive qubit readout across a wide range of cooperativities. Additionally, cavity-based schemes have realized remote entanglement between neutral atoms, and theory suggests that much higher entanglement generation rates are achievable with heralded schemes and improved system parameters.

However, integrating optical cavities with large-scale neutral atom arrays presents a significant challenge in the field. To date, cavity operations have been restricted to serial execution, with only one atom-cavity interaction occurring at a time. This limitation creates a bottleneck for protocols involving many atoms and hinders scalability to large arrays. Moreover, a fundamental tradeoff arises from the choice of cavity geometry. Cooperativity scales inversely with the mode area, so reducing the cavity mode size generally enhances photon collection efficiency and strengthens atom-photon coupling, enabling faster cavity-mediated operations. On the other hand, tighter mode confinement restricts the number of atoms that can be placed within the cavity mode. As a result, implementations based on small cavities often require transporting atoms into and out of the cavity mode, introducing additional time overhead for large-scale operations.

### SUMMARY

Here, we introduce cavity-mode multiplexing (CMM) for interacting with many atoms simultaneously via multiple modes of a single optical cavity. CMM leverages individually addressed light shifts to selectively couple atoms to distinct longitudinal and transversal cavity modes. This enables both spatial and frequency multiplexing of operations within the same cavity. By performing parallel cavity-enhanced processes on multiple atoms, CMM significantly increases operational throughput, thereby alleviating the single-mode tradeoff between cavity size and operation speed. This allows the use of larger cavities that can accommodate many qubits, reduces the need for atom transport, and ensures full compatibility with the capabilities of atom arrays. CMM can be employed for rapid syndrome extraction in QEC cycles by enabling fast, adaptive qubit measurements. Additionally, by enhancing remote entanglement rates while maintaining compatibility with high-fidelity intracavity Rydberg gates, it supports fast fault-tolerant operations between logical qubits in distinct modules. For both tasks, when applied to large-scale atom arrays, CMM offers a potential acceleration of approximately two orders of magnitude compared to architectures relying on free-space photon collection. Together, these capabilities establish CMM as a compelling approach to fast and scalable modular quantum computing with neutral atom arrays.

CMM can be implemented in a quantum processor that includes a cavity that supports many distinct cavity modes, an array of qubits trapped in the cavity, a cavity mode separator, and a detector array. Different qubits in the array of qubits are configured to emit photons into different cavity modes. The cavity mode separator, which is optically coupled to the cavity, maps the different cavity modes to distinct spatial channels. And the detector array, which is optically coupled to the cavity mode separator, detects the photons in the distinct spatial channels.

The cavity modes can include longitudinal cavity modes, transverse cavity modes, or both.

The qubits can include neutral atoms or ions. The array of qubits comprises can be divided into first and second registers coupled first and second cavity modes, respectively. These registers can be spatially separated from each other (e.g., they can be different columns or rows of the array of qubits).

The cavity mode separator can include a virtually imaged phased array (VIPA), a multi-plane light converter (MPLC), and/or a diffractive element.

The quantum processor can also include at least one first laser, in optical communication with the array of qubits, to tune the different qubits to be resonant or near-resonant with the different cavity modes. And it can include at least one second laser, in optical communication with the array of qubits, to couple the array of qubits to the cavity. The array of qubits can include a first qubit with a ground state |g [symbol] , an excited state |e [symbol] , and a higher-lying excited state |f [symbol] , in which case the first laser illuminates the first qubit with a control beam resonant or near-resonant with a transition from the excited state |e [symbol] to the higher-lying excited state |f [symbol] . In this case, the second laser can illuminate the first qubit with a probe beam that couples the first qubit to the cavity via an optical transition between the excited state |e [symbol] and the ground state |g [symbol] .

CMM can be carried be used to optically extract qubit states of qubits trapped in a cavity as follows. Photons from different qubits are coupled into different cavity modes and then out of the cavity, where they are separated as a function of cavity mode. The photons are then detected, e.g., with a detector array.

In some cases, the different qubits are syndrome qubits and optically extracting the qubit states is part of a search for syndrome qubits in an undesired qubit state, the undesired qubit state indicating an error in a quantum computation.

In other cases, the cavity is a first cavity and detecting the photons comprises interfering the photons with photons emitted by different qubits in a second cavity to generate Bell pairs. This distributes entanglement between the different qubits in the first cavity and the different qubits in the second cavity.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates cavity mode multiplexing with an array of neutral atoms trapped in a cavity that supports multiple (nondegenerate) resonant cavity modes, with each neutral atoms coupled to a different resonant cavity mode for parallel readout.

FIG. 1B shows a more detailed view of a cavity mode multiplexing system.

FIG. 2A illustrates how crossed acousto-optic deflectors (AODs) can be used to independently program atoms trapped in a cavity to be resonant with different cavity modes.

FIG. 2B illustrates how a fast spatial light modulator (SLM) can be used to independently shift atoms trapped in a cavity to be resonant with different modes of the cavity.

FIG. 2C illustrates how a static SLM in conjunction with a digital micromirror device (DMD) can independently tune atoms trapped in a cavity to be resonant with different cavity modes.

FIG. 2D shows how a power distribution network can divide light among an array of integrated optical modulators, each of which can turn the light on/off for tuning atoms trapped in a cavity to be resonant with different modes of the cavity. Each modulator provides dynamic control of the “on” level to set the power of the Stark shift for each atom.

FIG. 2E shows an array of integrated, independently controlled lasers that can directly tune atoms trapped in a cavity to be resonant with different cavity modes.

FIG. 3A shows a frequency comb source and an optical element that separates cavity modes for probing cavity-mode-multiplexed (CMM) atoms in parallel.

FIG. 3B shows an optical modulator array that creates specific target frequencies tailored for different CMM atoms using on-chip EOMs and optionally filtered by on-chip Mach-Zehnder interferometers that remove spurious sidebands.

FIG. 3C shows an array of integrated, independently controllable lasers that can directly address CMM atoms.

FIG. 4A illustrates a multi-plane light converter (MPLC) suitable for separating photons emitted by CMM atoms in the same cavity.

FIG. 4B shows a virtually imaged phased array (VIPA) suitable for separating photons emitted by CMM atoms in the same cavity.

FIG. 5 illustrates the energy levels of a neutral ⁸⁷Rb atom used for readout.

FIG. 6A is a plot of the heating rate of an atom in a 20 MHz and 1 μm trap as a function of temperature.

FIG. 6B is a plot of the scattering rate for nearest neighbor atoms in a cavity as a function of separation.

FIG. 7A is a plot of readout fidelity as a function of collection photon number for the virtually image phased array (VIPA) parameters in the specification.

FIG. 7B is a VIPA profile as a function of camera position along the x axis. The inset shows the atomic spectra.

FIG. 8A illustrates a cavity and 2D atomic-qubit-array configuration for syndrome readout using CMM with Hermite-Gauss (HG) modes, with the atomic level scheme used for qubit readout shown at right.

FIG. 8B is a plot of the cavity spectrum showing 50 equally spaced cavity modes spanning two FSRs. The vertical line height is used only to visually distinguish modes and does not represent a quantitative measure.

FIG. 8C shows spatial profiles of HG_{n,0} modes with indices n=0, 4, 7.

FIG. 8D is a plot of cooperativity per atom across the array in FIG. 8A (every 8th atom shown).

FIG. 9 is a plot of syndrome readout duration versus number of qubits (here, atoms) using free-space imaging (top trace), a single cavity mode (middle trace), and CMM over 50 cavity modes (bottom trace).

FIG. 10 illustrates remote entanglement generation between arrays of qubits trapped in different cavities, with each qubit coupled to a different cavity mode.

FIG. 11A shows a cavity and 1D atomic-qubit-array configuration for remote atom-atom Bell-state generation using CMM with Laguerre-Gauss (LG) modes, with the atomic level scheme for atom-photon entanglement via vSTIRAP shown at right.

FIG. 11B is a plot of equally spaced cavity resonances of 33 Laguerre-Gauss modes across a single FSR. Vertical line heights are used only for visual distinction and do not represent quantitative values.

FIG. 11C shows spatial profiles of LG modes with indices p=0, 2, 4, 8.

FIG. 11D is a plot of cooperativity reduction of each cavity mode as a function of temperature.

FIG. 12 is a plot of photon generation for remote entanglement using vacuum-stimulated Raman adiabatic passage (vSTIRAP).

### DETAILED DESCRIPTION

An optical resonator can be used for fast, parallel, and nondestructive readout of qubits. By leveraging multiple longitudinal and/or transverse modes of a single cavity, each qubit can be read out at distinct optical frequencies, effectively coupling each atom to a unique cavity mode. This approach addresses the limitations of traditional sequential readout methods by enabling simultaneous readout of many qubits with minimal cross-talk and high fidelity. The qubit/cavity system, supported by detailed design considerations including light shifts, cavity geometry, and the use of highly dispersive elements such as virtually imaged phased arrays (VIPAs) or transverse mode separators such as multi-plane light converters (MPLC) s, enable parallel operations on atomic or ionic qubits. This scheme provides a scalable and efficient solution for the parallel state readout and remote entanglement generation of large-scale atom arrays.

### Cavity Mode Multiplexing Systems

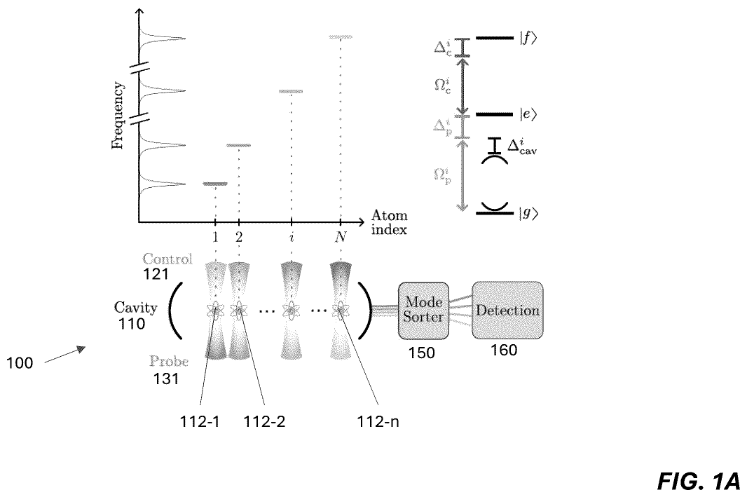

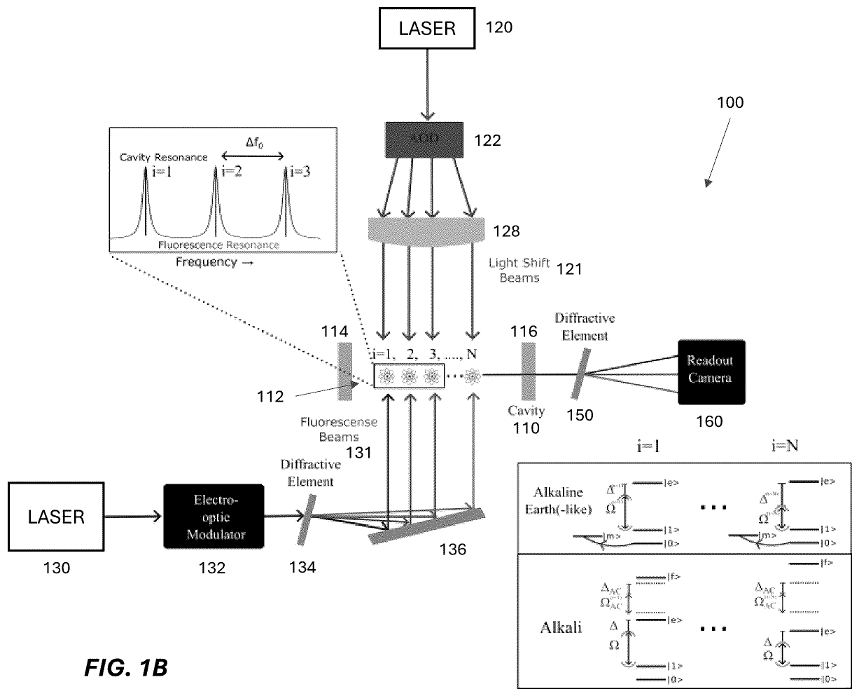

FIG. 1A illustrates a cavity mode multiplexing (CMM) system 100 with a register or array of qubits 112-1 through 112-n (collectively, qubits 112) trapped inside a Fabry-Pérot optical cavity 110 with optical tweezers (not shown). The cavity 110 supports a rich mode structure comprising both longitudinal and higher-order transverse modes. Longitudinal modes of a fixed transverse profile (e.g., TEM₀₀) are evenly spaced by the free spectral range (FSR) of the cavity 110. Within each FSR, higher-order transverse modes exhibit distinct resonance frequencies due to their differing spatial profiles. Together, this structure provides a versatile set of spectrally resolved cavity modes that can be harnessed for CMM.

The minimal atomic level configuration of the qubits 112 includes three states: a ground state |g [symbol] , an excited state |e [symbol] , and a higher-lying excited state |f [symbol] . The cavity mode couples to the |g [symbol] →|e [symbol] atomic transition. To locally control this transition frequency, additional control beams 121 addressing each qubit 112 couple the excited state |e [symbol] to |f [symbol] with Rabi frequency Ω_{c} and detuning Δ_{c}, inducing a light shift on |e [symbol] . Since the control beams 121 are far detuned from any ground-state transitions, the ground state |g [symbol] remains essentially unaffected. Control beams 121 can be used to selectively decouple qubits 112 from a single cavity mode. With additional polarization control to address specific magnetic sublevels, these shifts can also be used to modify cavity-mediated photon-atom gate dynamics.

In the CMM system 100 of FIG. 1A, the induced shift allows the |g [symbol] →|e [symbol] transition of each qubit 112 to be independently coupled to a separate cavity mode, effectively providing each qubit 112 with its own dedicated cavity. This configuration supports multiplexed, cavity-enhanced operations across the entire atomic register (array of qubits 112). As an illustrative example, consider the case where photons scattered by different qubits 112 are simultaneously collected through separate cavity modes. As depicted in FIG. 1A, for each atom i in the register, a probe field 131, also called a probe beam or fluorescence beam, drives the shifted transition with Rabi frequency

$${Ω}_{p}^{i}$$

and detuning

$${Δ}_{p}^{i} .$$

The detuning of the corresponding cavity mode from the probe frequency is denoted by

$${Δ}_{cav}^{i} .$$

### Setting

$${Δ}_{cav}^{i} = 0$$

ensures maximal photon collection efficiency. In this way, photons scattered by all qubits 112 in the register are simultaneously collected through their assigned cavity modes.

A cavity mode separator 150 in optical communication with the cavity 110 differentiates the light scattered by each qubit 112 by resolving the corresponding transverse and longitudinal cavity modes. The cavity mode separator 150 may separate transverse cavity modes with a multi-plane light converter (MPLC), which performs arbitrary unitary transformations of spatial modes through a sequence of phase masks separated by optical Fourier transform or free-space propagation. An MPLC can convert co-located high-order spatial modes into spatially distinct Gaussian beams, scaling to more than a thousand modes. An MPLC can be implemented using a programmable spatial light modulator (SLM); however, for static mode sorting, where the desired phase remains fixed, custom-fabricated phase masks offer an improved alternative, providing higher spatial resolution with lower optical losses. Longitudinal modes, separated in frequency by the cavity FSR, can be spatially separated using a high-resolving power dispersive element such as a virtually imaged phased array (VIPA), which enables frequency resolution in excess of 10⁶, or a diffraction grating. Depending on the intended application, the separated cavity modes can then be imaged onto a detector array 160 or coupled into single-mode fibers and directed to single-photon detectors for high-efficiency counting.

Achieving multiplexing across many modes while maintaining low crosstalk involves large light shifts over many qubits 112. To keep the optical powers at practical levels, the on-resonance control light 121 (Δ_{c}=0) dresses the states |e [symbol] and |f [symbol] , producing new eigenstates |e_{±} [symbol] =|e [symbol] ±|f [symbol] /\sqrt{2}. This results in ground-to-dressed-state transitions with frequencies ∓Ω_{c}/2 relative to the original |g [symbol] →|e [symbol] transition. The maximum frequency shift, Ω_{c}/2, is constrained such that intensity fluctuations produce frequency variations on the order of the excited-state linewidth Γ. For on-resonance control light with 0.1% intensity stability, this permits frequency shifts of up to 2000Γ. The mixing of |e [symbol] and |f [symbol] also reduces the atom-cavity coupling strengths, as there is no direct |g [symbol] →|f [symbol] coupling, and modifies the dressed-state linewidths compared to the bare state |e [symbol] . These effects are incorporated into the analysis below for applications of CMM. While the following discussion focuses on implementation of CMM with ⁸⁷Rb, the inventive concepts are readily applicable to other alkali and alkaline-earth species.

FIG. 1B shows a specific implementation of the CMM system 100 using longitudinal modes to read out different qubits, such as ions or neutral atoms, simultaneously with a cavity or optical resonator. This system 100 includes one or more single-transverse-and-longitudinal-mode lasers 120, 130 that illuminate an array of qubits 112 trapped in the cavity 110, which is formed by a pair of mirrors 114 and 116, at least one of which (mirror 116) is partially transmitting. (Other types of cavities are also possible, including bowtie cavities as discussed below.) The laser parameters depend on the type of atom or ion being addressed. The laser(s) 120 illuminates the qubits 112 with addressing beams 121, 131 from the side, causing the qubits to emit photons into different cavity modes (different wavelengths/frequencies)—simultaneously, if desired. The addressing beams include beams 131 that induce fluorescence into the cavity 110 and beams 121 that light shift the atoms 112 near the resonance of their particular cavity mode as described above. The fluorescence beams 131 can be generated using an electro-optic modulator (EOM) 132 in conjunction with a diffractive element 134, such as a virtually imaged phased array (VIPA), and a mirror 136. The light-shifting beams 121 can be generated using an acousto-optic deflector (AOD) 122 and a collimating lens 128, since the absolute frequency of the light-shifting beams 121 does not matter and can be compensated by increasing the power of that beam in the relevant diffraction order from the AOD 122. The partially transmitting mirror 116, also called an output coupler, couples the photons in these cavity modes out of the cavity 110. A cavity mode separator 150, such an MPLC, VIPA, and/or diffraction grating, spatially separates the photons by cavity mode (frequency) for (simultaneous) detection by a readout camera 160 or other suitable detector array. Alternatively, the photons can be mixed with local oscillators for heterodyne detection.

The qubits 112 in the cavity 110 can be ions or neutral atoms, such as alkali atoms or alkaline earth atoms. For alkali atoms, each atom has four relevant levels: |0 [symbol] and |1 [symbol] are the qubit states, |e [symbol] is a cycling fluorescence transition, and |f [symbol] is used to light shift the resonance frequency of the cycling transition with minimal effects on the ground qubit states. Alkali atoms are both light-shifted into near-resonance to a longitudinal TEM₀₀ mode of the cavity and illuminated with a fluorescence beam 131 with a frequency that matches the corresponding cavity mode. For an alkaline earth atom, the light-shift level |f [symbol] can be omitted since an alkaline earth atom in the |0 [symbol] state can be stored in a metastable level |m [symbol] or a large magnetic field can separate out neighboring excited state levels, which eliminates the effect of depumping. Each alkaline earth atom is illuminated by a fluorescence beam 131 with an intensity that matches the resonance to a distinct cavity mode. Finally, for both element alkali and alkaline earth atoms, the spatially overlapped light is separated out using the cavity mode separator 150 and imaged onto a detector array or readout camera 160, enabling the determination of the qubit state.

### Light Shifting/Control Beam Schemes

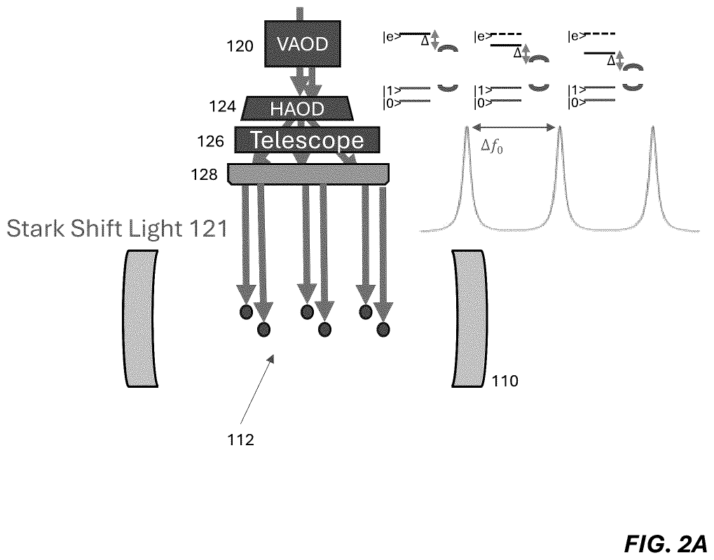

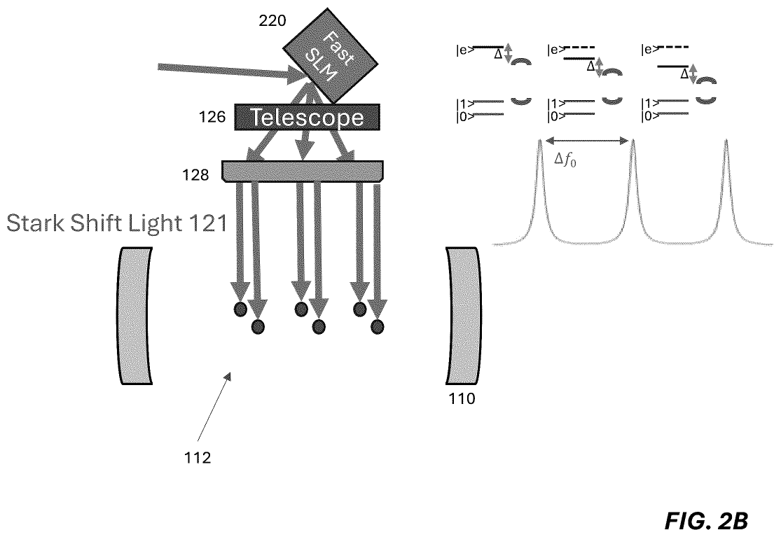

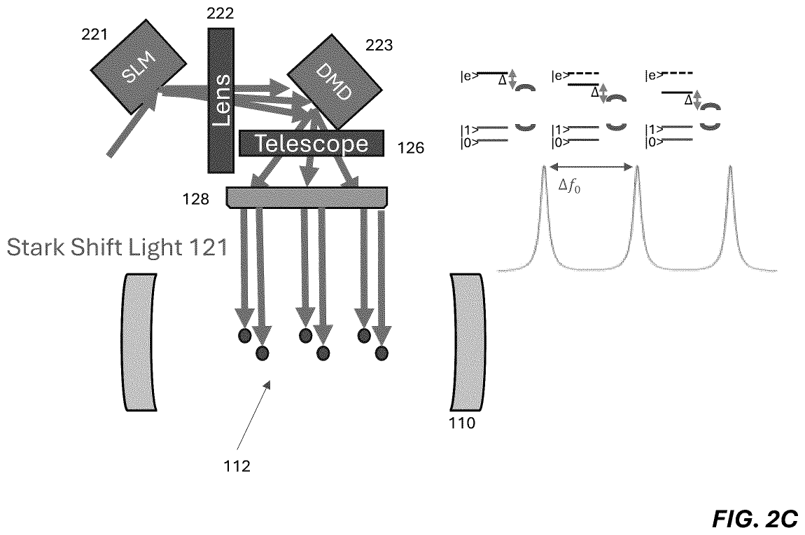

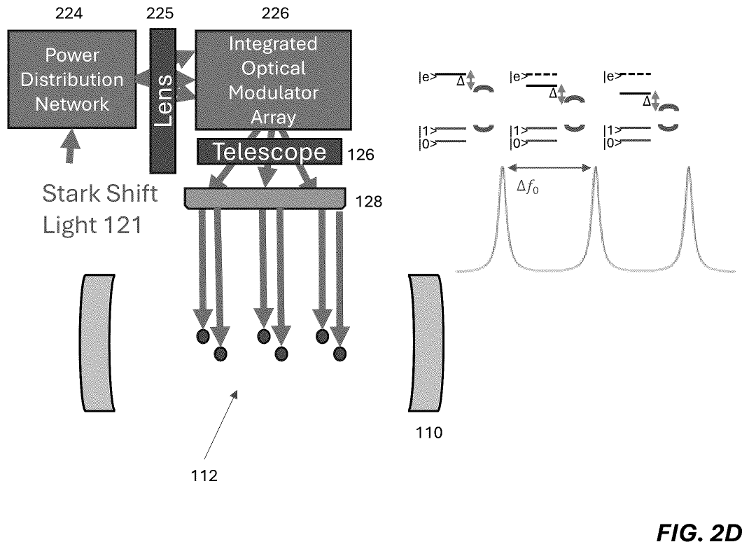

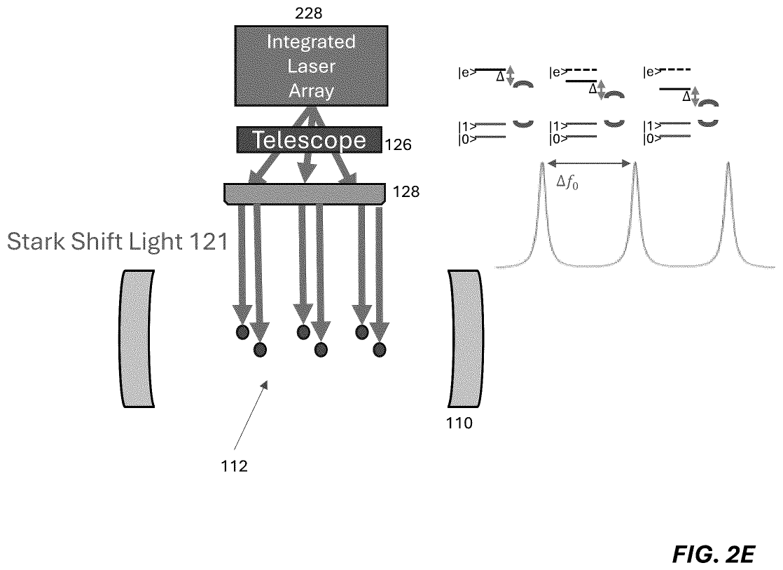

FIGS. 2A-2E illustrate different schemes for frequency-shifting the ground states of different qubits to be resonant with different, non-degenerate cavity modes. Each scheme involves creating an array of control beams 121, also called Stark shift or light shift beams 121, that can address the qubits 112 in an arbitrary way, possibly with fast switching between different addressing patterns depending on the application. In each scheme, the powers of the Stark shift beams 121 are controlled independently of each other. These schemes apply to both one-dimensional (1D) and two-dimensional (2D) qubit arrays with arbitrary qubit ordering.

FIG. 2A shows how to generate Stark shift beams 121 using a pair of crossed AODs 120 and 124, which together can be used to address a 2D array of qubits 112 row-by-row or column-by-column. (A single AOD 120 is sufficient for addressing a 1D array of qubits 112.) The first AOD 120 deflects a Stark shift beam 121 from the laser 120 (FIG. 1B) vertically, and the second AOD 124 deflects the Stark shift beam 121 horizontally. A telescope 126 and collimating lens 128 project the deflected Stark shift beam 121 onto the qubit(s) 112 being addresses. One or both of the AODs 120, 124 can modulate the Stark shift beam's power level in addition to deflecting the Stark shift beam 121.

FIG. 2B shows a fast reflective spatial light modulator (SLM) 220 that directly routes power independently to each qubit 112 in the cavity 110. The SLM 220 switching speed is comparable to the speed of the cavity ringdown time so that the SLM 220 can switch addressing patterns on the timescale of qubit-cavity interaction times. Driving the SLM 220 with an appropriate signal steers the control beam(s) 121 to different qubits 112 in the cavity 100.

FIG. 2C shows a static SLM221 that can route power independently to each qubit in conjunction with a lens 222 and a digital micromirror device (DMD) 223. DMDs typically have faster update rates than SLMs and so can be used to steer the control beams 121 among the qubits 112 at higher speeds.

FIG. 2D shows how a power distribution network 224 and a lens 225 divide light among integrated optical modulators 226 in an array. The control beam 121 from each modulator 226 is fixed on a particular qubit 112. Each modulator 226 can turn its control beam 121 on and off during readout to control the shift applied to its qubit 112. In addition, each modulator 126 has dynamic control of the “on” level of its control beam 121, making it possible to set the power of the Stark shift for each qubit 112.

FIG. 2E shows an integrated laser array 228 for tuning qubits 112 into resonance with different cavity modes. The integrated laser array 228 may include one laser per qubit 112, with the telescope 126 and lens 128 project the control beam from that laser to the corresponding qubit 112. Each laser's output power can be controlled independently of the other lasers in the laser array 228, so each laser can tune its qubit 112 independently of the other qubits 112.

### Probe Beam Schemes

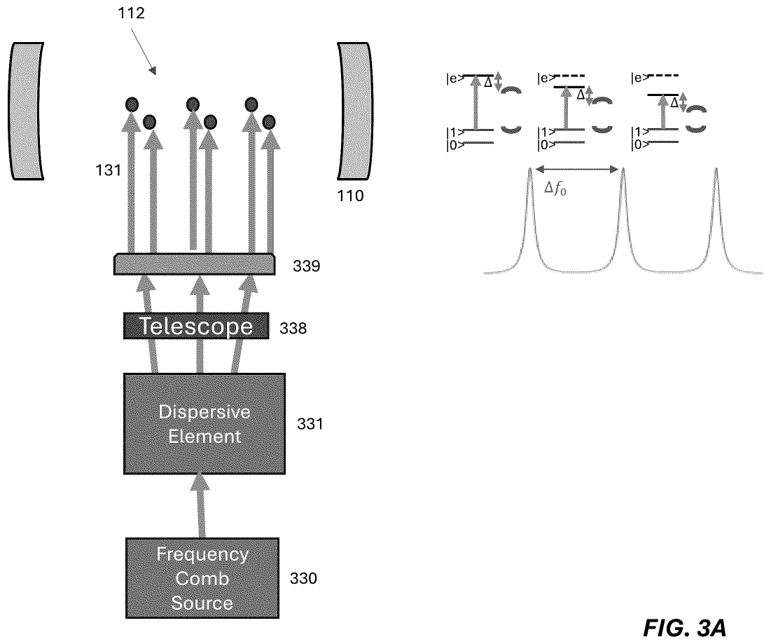

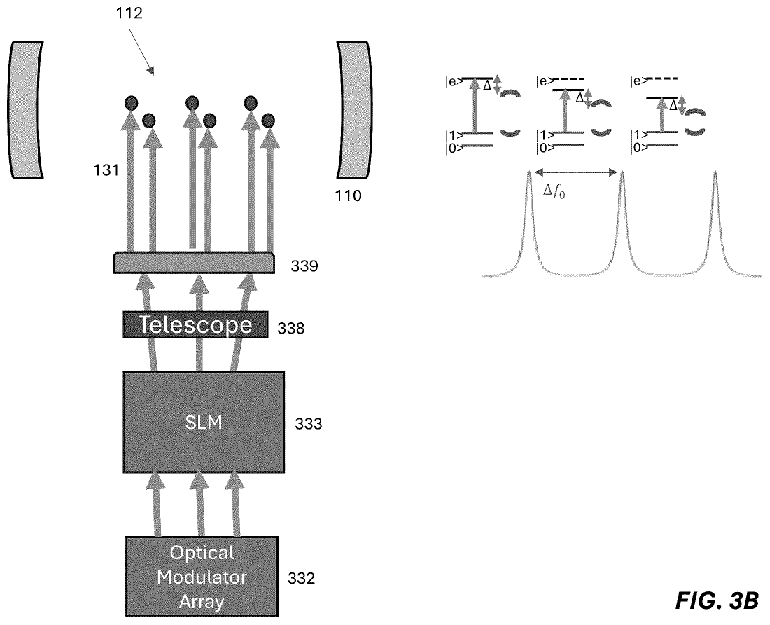

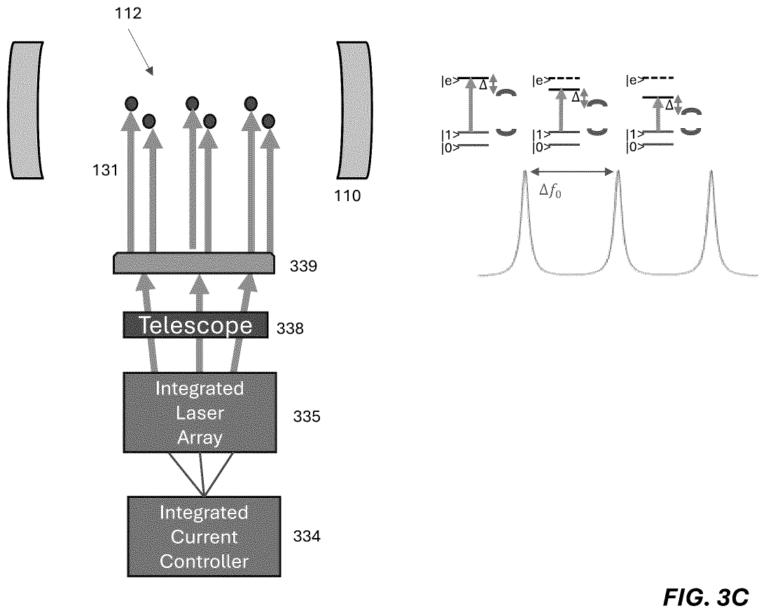

FIGS. 3A-3C depict different schemes for addressing qubits 112 (e.g., atoms or ions) with probe beams 131. Each scheme involves creating an array of probe beams 131 that address the qubits 131 in an arbitrary way, where each probe beam 131 can have a different frequency and power, both of which are controlled at the same time. These schemes can spatially resolve qubits 112 in a 2D array with arbitrary ordering with a (spectral) frequency resolution similar to the cavity linewidth.

FIG. 3A shows a frequency comb source 330 and a dispersive element 331 that generate probe beams 131 for addressing CMM qubits 112. Both can be free-space elements or integrated in a photonic integrated circuit (PIC). In a PIC, the frequency-comb source 330 and dispersive element 331 could be implemented with, for example, a micro-ring cavity in a Kerr-active material and an arrayed waveguide grating (AWG), respectively. In free-space, they could be implemented by a mode-locked laser with a free space cavity housing an EOM, saturable absorber, or Kerr-active material, and a free-space dispersive element, e.g., a grating.

FIG. 3B shows an optical modulator array 332 with on-chip EOMs that generate probe beams 131 at target frequencies tailored for each qubit 112. The probe beams 131 can be optionally filtered by on-chip Mach-Zehnder interferometers that remove spurious sidebands. An SLM 333, telescope 338, and collimating lens 339 direct the probe beams 131 emitted by the optical modulator array 332 to the respective qubits 112.

FIG. 3C shows how an array of integrated lasers 335 can directly address qubits 112 independently. Each laser 335 generates a probe beam 131 for addressing a particular qubit 112. The lasers 335 are coupled to and controlled by an integrated current controller 334 that controls the current and hence the output power and lasing frequency for each laser 335.

### Sorting Cavity Modes

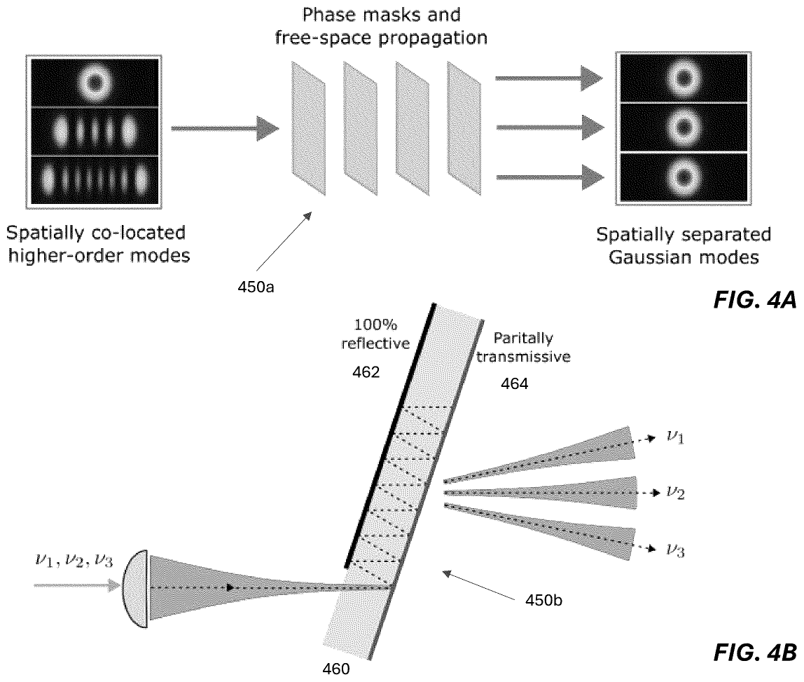

FIGS. 4A and 4B show different mode sorters suitable for sorting or demultiplexing the outputs of CMM qubits 112. FIG. 4A illustrates a multi-plane light converter (MPLC) 450a, which is a versatile device that implements arbitrary unitary transformations of spatial modes with a sequence of phase masks separated by optical Fourier transforms or free-space propagation. This approach enables the conversion of co-located higher-order spatial modes into spatially distinct Gaussian beams and can be scaled to more than a thousand modes. The MPLC 450a can be realized by reflecting the beam back and forth between a mirror (not shown) and multiple regions of a phase mask plane. The phase plane may be implemented using a programmable SLM, which offers flexibility in defining the required phase profiles. For static mode sorting, however, where the transformation remains fixed, custom-fabricated phase masks may provide a more practical alternative, offering finer spatial resolution with lower optical loss. With this capability, the MPLC 450a provides a powerful and scalable solution for separating higher-order cavity modes at the cavity output while maintaining low crosstalk.

FIG. 4B shows a virtually imaged phased array (VIPA) 450b, which is a high-resolution dispersive element based on a tilted glass plate 460, where one side is fully reflective 462 and the other side 464 is partially transmissive. A focused input beam undergoes multiple reflections between the two surfaces, and at each reflection a fraction of the light exits through the partially transmissive side. These transmitted beams form a series of virtual sources aligned along the normal to the plate, which collectively act as an optical phased array. The interference of these sources produces an output beam at a wavelength-dependent angle, resulting in strong angular dispersion. This high resolving power makes the VIPA 450b particularly useful for spatially separating cavity modes with closely spaced frequencies, enabling high-fidelity discrimination even for frequency differences on the order of 100 MHZ.

### Syndrome Extraction Using Parallel Cavity Operations

One function of non-destructive qubit readout in error-corrected quantum computing is to perform mid-circuit measurements (MCMs) of syndrome qubits, also called ancilla qubits. These measurements are used to identify and correct errors occurring on the data qubits, which encode and process the logical quantum information throughout the quantum computation. In neutral atom arrays, syndrome extraction via free-space imaging typically takes a few milliseconds, constituting a substantial fraction of the quantum error correction (QEC) cycle and, consequently, imposes a limitation on the overall computation rate.

Optical cavities help overcome this bottleneck by enabling non-destructive qubit readout on the microsecond timescale. In cavity-enhanced readout, the qubit is typically encoded in two ground states, with the |1 [symbol] →|e [symbol] transition coupled to the cavity mode. The atomic state is then determined based on its coupling—or lack thereof—to the cavity mode. Common techniques include fluorescence detection, where probe light addressing the |1 [symbol] →|e [symbol] transition is applied via an external beam and scattered photons collected through the cavity; and transmission detection, where an atom in |1 [symbol] suppresses on-resonance cavity transmission. However, even with microsecond-scale qubit readout, sequentially measuring thousands of syndrome qubits extends the total duration to the millisecond range. In this regime, the added complexity of integrating a cavity offers limited benefit compared to parallel free-space imaging, which can simultaneously read thousands of qubits.

For syndrome extraction, the ability to couple multiple qubits simultaneously to the same cavity mode provides a significant advantage, enabling more efficient readout strategies than sequential readout. In practical quantum computers, the physical qubit error rates are expected to be small. This implies that the vast majority of syndrome qubits will occupy the |0 [symbol] state (indicating the absence of an error) while only a small fraction will be in the |1 [symbol] state (signifying the presence of an error). This bias can be exploited to perform global checks: rather than measuring each syndrome qubit individually, one can probe an entire batch of n_{batch} atoms simultaneously to determine whether any are in |1 [symbol] . If no error is detected—an outcome that is likely given the low error probability—the procedure advances directly to the next batch. If an error is detected, an adaptive binary search can be performed by selectively decoupling subsets of atoms from the cavity mode through controlled light shifts, enabling efficient identification of the faulty syndrome qubit(s). In cases where multiple erroneous syndromes are present within the same batch, the global check and binary search sequence are repeated until all errors are located. For an independent probability of a faulty syndrome P_{synd}, the expected number of queries m required per batch is

$$m = 1 + {n}_{batch} {P}_{synd} [ 1 + {log}_{2} ( {n}_{batch} ) ] ,$$

where the first term corresponds to the single global check. The second term accounts for the additional queries required when faulty syndromes are present: each faulty syndrome triggers a binary search, followed by a global check to confirm that no further faulty syndromes remain within the batch. This process involves 1+log ₂ (n_{batch}) queries per faulty syndrome and is multiplied by the expected number of faulty syndromes per batch, n_{batch}P_{synd}.

With a single cavity mode, the expected number of steps for processing N syndrome qubits is

$$\# steps = ⌈ \frac{N}{{n}_{batch}} ⌉ \times m ,$$

where ┌N/n_{batch}┐ is the number of batches that are processed sequentially. For P_{synd}=5×10⁻³, a maximum batch size of n_{batch}=256, and a query time of 10 μs, the total readout duration enters the millisecond regime when N≈2000 atoms, not accounting for additional time overhead from transporting atom batches in and out of the cavity. Therefore, even with adaptive searches, a single cavity mode does not provide a net advantage over parallel free-space imaging. If, however, adaptive searches can be performed in parallel across multiple registers—each coupled to a distinct cavity mode—the scaling improves to

$$\# steps = ⌈ \frac{N}{{n}_{batch} {n}_{modes}} ⌉ \times m ,$$

where n_{modes} denotes the number of available modes.

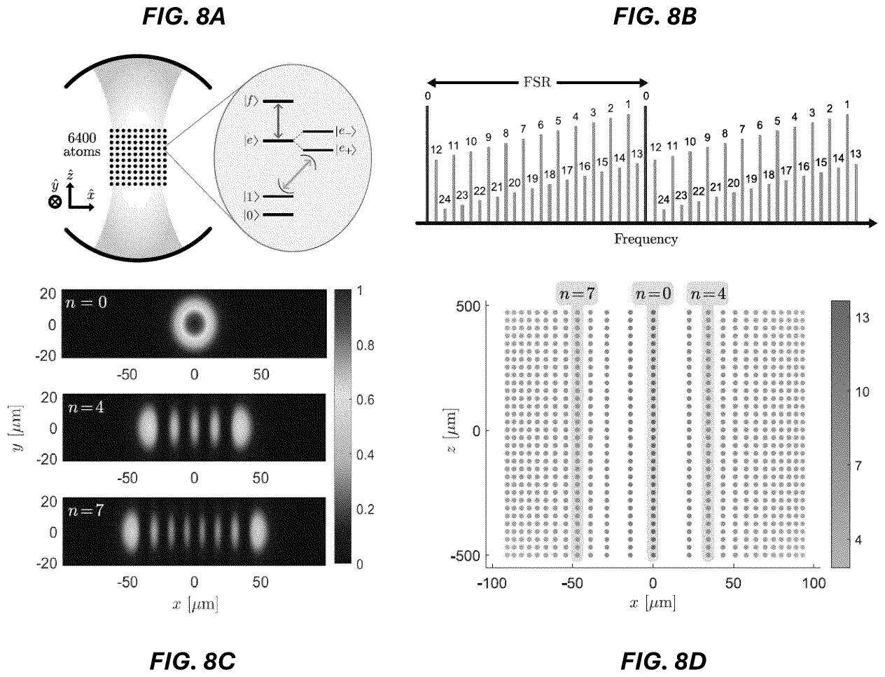

FIGS. 8A-8D illustrates how to realize this parallelism for syndrome extraction using CMM with a design tailored to ⁸⁷Rb atoms. FIG. 8A shows a cavity and atom-array configuration for syndrome readout using CMM with Hermite-Gauss (HG) modes. The atom array may include up to 6400 atoms, organized in different registers, with each register coupled to a different cavity mode. The cavity has a spectrum with 50 equally spaced cavity modes spanning two FSRs as shown in FIG. 8B, with different modes having different spatial profiles, e.g., as shown in FIG. 8C for HG_{n,0} modes with indices n=0, 4, 7.

FIG. 8D shows how the atoms are arranged in the cavity—the atoms are placed at the intensity maxima of the HG_{n,0} modes, with even (odd) values of n assigned to the positive (negative) x-axis. Each column is divided into two registers, which couple to two longitudinal cavity modes with the same transverse profile, separated in frequency by one FSR. The shading of the atoms in FIG. 8D indicates the atoms' cooperativities.

For syndrome extraction using ⁸⁷Rb atoms in the scheme shown in FIGS. 8A-8D, the relevant atomic states are

$$\vert 0 〉 ≡ \vert 5 {S}_{1 / 2} , F = 1 , {m}_{F} = 1 〉$$

$$\vert 1 〉 ≡ \vert 5 {S}_{1 / 2} , F = 2 , {m}_{F} = 2 〉$$

$$\vert e 〉 ≡ \vert 5 {P}_{3 / 2} , {F}^{′} = 3 , {m}_{F} = 3 〉$$

$$\vert f 〉 ≡ \vert 4 {D}_{5 / 2} , {F}^{″} = 4 , {m}_{F} = 4 〉 .$$

These qubit states are employed solely during readout; the qubit (⁸⁷Rb atom) need not remain encoded in these states throughout computation. Since the measurement projects the qubit into either |0 [symbol] or |1 [symbol] , coherence preservation is not required at this stage, which simplifies changing the basis from the computational encoding—typically the clock states with m_{F}=0-to the readout encoding. The use of the cycling transition for |e [symbol] →|f [symbol] prevents mixing with other states that could induce readout errors via depumping channels from |1 [symbol] to |0 [symbol] .

For this atomic configuration, we consider a Fabry-Pérot optical cavity characterized by the parameters summarized in TABLE 2. We tune the cavity such that the higher-order Hermite-Gauss (HG) modes along the transverse x-axis, HG_{n,0} with n ∈[0,24], are arranged to be equally spaced in frequency within the FSR, with a 240 MHz separation between adjacent modes. Using these HG modes across two FSRs provides access to a total of 50 equally spaced cavity modes as shown in FIG. 8B. The control beams, resonant with the |e [symbol] →|f [symbol] transition, are used to dress the excited states, allowing to tune the |1 [symbol] →|e₊ [symbol] transition of each atom to couple to the appropriate cavity mode. The total frequency range spans 12 GHZ, and with 0.1% intensity stability of the control field, the resulting variation of the ground-to-dressed-state transition frequency is limited to the linewidth of |e [symbol] , Γ/2π=6 MHz.

TABLE 2
Parameters of the optical cavity used for syndrome extraction.

| | |
|---|---|
| Cavity length | 25 mm |
| Mode waist | 20 μm |
| Rayleigh range | 1.6 mm |
| Finesse | 6 × 10⁴ |
| FSR | 6 GHz |
| Linewidth (FWHM) | 100 kHz |

In addition to parallelized syndrome extraction, this architecture increases the number of atoms that can be accommodated within the cavity. Rather than being restricted to the spatial extent of the fundamental HG₀₀ Gaussian mode, columns of atoms are arranged along the z-axis at the intensity maxima of each higher-order HG mode, positioned at different points along the x-axis as shown in FIG. 8C. To reduce crosstalk and increase the spatial separation between adjacent columns of atoms, we assign modes with even (odd) n to the positive (negative) x-axis, taking advantage of the symmetry of the intensity peaks about the y-axis. With a minimum spacing of about 4 μm between adjacent atoms, this arrangement allows up to 6400 atoms to couple to some cavity mode at once, enabling simultaneous operations on 50 distinct batches of 128 atoms each.

FIG. 8D shows the cooperativity η per atom for the |1 [symbol] →|e₊ [symbol] transition, accounting for (i) the reduction in atom-cavity coupling and decay rate due to the dressed-state nature of |e₊ [symbol] , (ii) the Gaussian mode Rayleigh range, which reduces coupling for atoms farther from the cavity center along z, and (iii) the electric field profile of higher-order modes, which results in lower atom-cavity coupling as n increases. The resulting average cooperativity is η̅=6.7. This configuration enables fast, high-fidelity fluorescence readout. The atoms are individually addressed by probe beams with Rabi frequency Ωₚ/2π=15 MHz and detuning Δₚ/2π=120 MHz relative to the dressed transition of each atom, while the corresponding cavity mode is kept on resonance with the probe field (Δ_{cav}=0). Under these conditions, each atom in state |1 [symbol] scatters 20 photons into the cavity mode within 10 us at an average collection efficiency of ˜87%. The combination of individual probe addressing and frequency separation between cavity modes suppresses crosstalk to below 10⁻⁵. Furthermore, the frequency stability of the dressed state ensures that readout times vary by less than 10%, as the frequency fluctuations are small compared to the probe detuning Δₚ. Alternatively, other readout techniques could be employed to achieve comparable or improved performance by coupling light into the different cavity modes via the mode sorter.

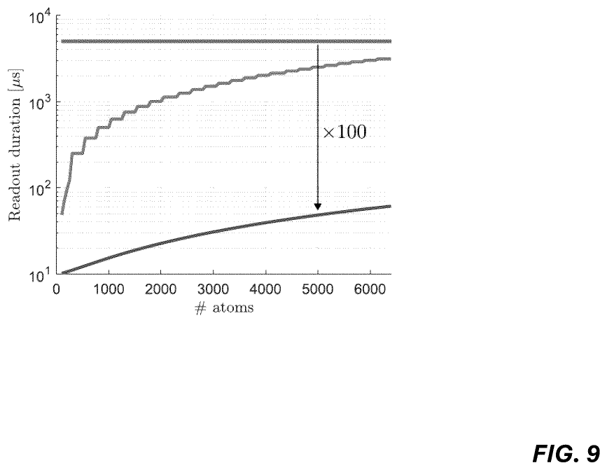

With 50 available modes and a query time of 10 μs, this design yields a substantial improvement in syndrome extraction speed. FIG. 9 compares the scaling of syndrome readout duration with the number of atoms for three cases: a 5 ms free-space readout; adaptive searches utilizing a single cavity mode; and adaptive searches employing 50 cavity modes. As discussed above, a single-mode system reaches the millisecond timescale at approximately 2000 atoms. However, CMM with 50 modes reduces the readout duration by more than two orders of magnitude over free-space imaging, completing syndrome extraction in 50 μs for 5000 atoms. Beyond this speedup, cavity readout also strongly suppresses decoherence of the data qubits from stray photon scattering: in free-space imaging a large fraction of photons are emitted into uncontrolled directions, including toward the data qubits, whereas in the cavity configuration about 87% of the photons are collected into the cavity modes, thereby drastically reducing this effect.

This syndrome extraction scheme is fully compatible with a zoned architecture for neutral atom arrays. Entanglement via Rydberg gates can be performed within the cavity, and the readout zone described in this design spans only 200 μm along the x-axis. This zone can be further restricted to a subset of the available sites while still maintaining an average cooperativity of η̅>6. Individual control over the light dressing beams in two dimensions makes it possible to fully exploit the benefits of adaptive search.

### Remote Entanglement and Modular Connectivity

Another application for parallel readout using CMM is entanglement distribution. Cavities enhance the rate of Bell pair generation, which is useful for quantum communication and networking protocols. By enabling parallel operation within a single cavity, parallel readout could significantly increase entanglement rates, potentially overcoming the current bottlenecks in quantum network scalability and interconnects.

As atom array sizes advance into the regime of thousands of qubits, further scaling is expected to encounter significant technical challenges, including the demands for higher laser powers, larger microscope fields of view with finer spatial resolution, and beam uniformity over larger areas. Current estimates for utility-scale quantum computation indicate that millions of qubits may be required to implement practical, fault-tolerant algorithms. A promising route toward achieving this scale is a modular architecture, in which fixed-size atom array nodes are interconnected via optical links, thereby enabling distributed quantum computation. With an appropriately designed light-matter interface, such a modular scheme can, in principle, be scaled to arbitrarily large system sizes. Another advantage of this approach is its flexibility, as it allows the array size within each module to be tailored to optimize operational performance—such as high-fidelity gates—while avoiding the physical constraints that arise in very large monolithic arrays.

At the heart of such a modular design lies the ability to generate remote entanglement between nodes. Bell pairs shared across different modules, together with local operations at each node, provide the building blocks for inter-module operations. As a concrete example, we consider the implementation of teleported CNOT gates between qubits located in different nodes, which can be used to fault-tolerantly connect logical qubits encoded in surface codes across separate modules. The protocol begins with the distribution of a remote Bell state between two communication qubits. Each communication qubit is then entangled with a corresponding code qubit at the same node via a local CNOT gate. The communication qubits are subsequently measured, and the outcomes are classically communicated to determine the appropriate single-qubit rotations to apply to the code qubits. This sequence of operations results in the realization of a teleported CNOT gate between the remote code qubits. Overall, the procedure combines several essential capabilities: remote Bell state generation, local single- and two-qubit gates, and qubit readout. Achieving a high QEC cycle rate requires that all these operations be executed within a short timescale.

There are several approaches for generating a Bell state between two remote qubits. Here, we focus on a scheme in which atom-photon entanglement is first prepared independently at each node by emitting a single photon from each communication atom. Photons from different nodes—each entangled with its local qubit—are then routed to a probabilistic Bell-state measurement (BSM), which heralds the creation of an atom-atom Bell state. The main benefit of this scheme lies in its heralding property: only successful events are retained, ensuring that subsequent operations are performed on a known entangled state. However, since the BSM relies on detection of both photons, the overall success probability for generating atom-atom entanglement scales quadratically with the photon collection efficiency,

$${P}_{s} = \frac{1}{2} {( {α}_{interface} \times {α}_{setup} )}^{2} ,$$

where the factor of ½ reflects the intrinsic success probability of the BSM, α_{interface} denotes the probability of obtaining a photon at the cavity output, and αₛₑₜᵤₚ accounts for the efficiency of the optical setup, including fiber coupling, all optical elements in the path, and detection efficiency.

In free-space implementations, high-numerical-aperture lenses are used to collect the emitted photons, but their limited collection efficiency restricts Bell pair generation rates to about 200 Hz. A notable advantage of the free-space approach is its ability to attempt entanglement generation in parallel across many communication qubits, leading to a linear scaling of the total rate with the number of available qubits. For example, with about 5000 communication atoms, rates approaching the MHz regime could be achieved, albeit at the cost of dedicating a considerable fraction of the total array to communication rather than computation. However, even at these high entangling rates, inter-module operations would remain limited by the qubit readout duration, typically on the order of a few milliseconds.

Optical cavities provide an efficient atom-photon interface, significantly improving photon collection and enabling higher Bell pair generation rates. Arrays of microcavities have been proposed as a path towards generation rates in the tens of MHz, with individual microcavities achieving up to 2.4 MHz. Within a single cavity mode, Bell-state generation attempts must be performed sequentially, and in small-mode-volume cavities, which can accommodate only a few atoms, the attempt rate is limited by the speed of atom transport through the cavity. Additionally, in such compact architectures, local operations can further limit the rate of teleported CNOT gates. Qubit readout could be performed either via free-space imaging, which is slow, or via cavity-based measurement, which requires transporting all communication qubits that successfully generated Bell pairs back into the cavity, introducing substantial time overheads. Additionally, for microcavities, executing two-qubit Rydberg gates would likely require atom transport to a suitable distance away from the cavity structure, adding further complexity to the implementation. Relying on atom transport slows inter-module operations and can reduce their fidelity, as decoherence may result from the associated time delays and excessive atom heating during movement.

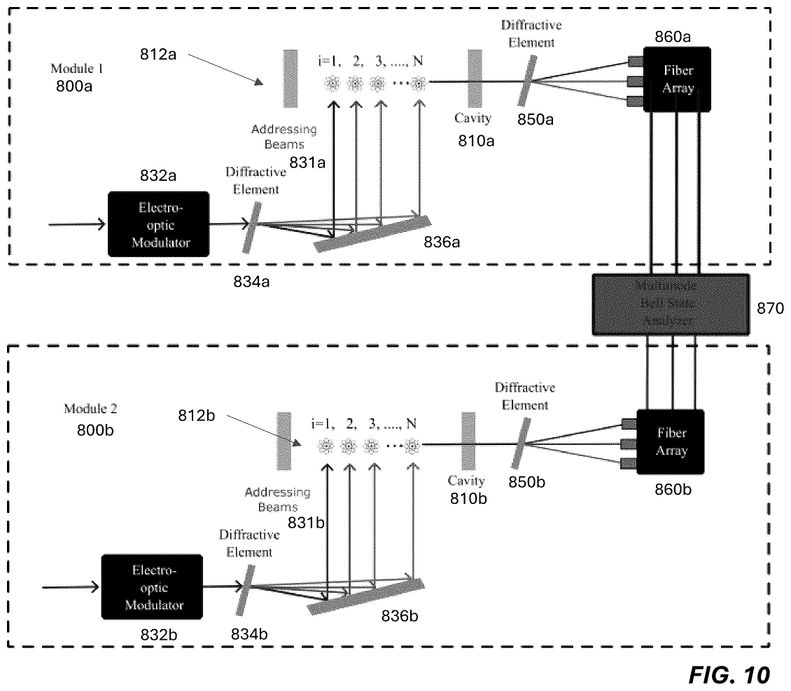

FIGS. 10-12 illustrate remote entanglement using CMM. This CMM-based approach enables parallel Bell-state generation attempts within a cavity that can host many qubits and remains compatible with Rydberg gates, thereby eliminating the reliance on atomic motion.

FIG. 10 illustrates remote entanglement generation between quantum processor modules 800a and 800b. Each module 800a, 800b contains atoms 812a, 812b coupled to distinct modes of a corresponding cavity 810a, 810b. The atoms 812a, 812b are illuminated by addressing/fluorescence beams 831a, 831b generated and routed with respective EOMs 832a, 832b, diffractive elements 834a, 834b, and mirrors 836a, 836b as described above with respect to FIG. 1B. These addressing beams 831a, 831b induce atomic emission of photons into the corresponding cavity 810a, 810b at unique frequencies, which are spatially separated by a corresponding optical element 850a, 850b (e.g., a VIPA or MPLC) and directed into a corresponding array of optical fibers 860a, 860b. Fiber pairs between modules 800a, 800b direct photons of the same frequency emitted by two atoms in different modules 800a, 800b to a detector in the form of a Bell state analyzer 870, which projectively creates entanglement between atom pairs in the different modules 800a, 800b. This then enables parallel remote entanglement generation simultaneously for multiple atoms. This scheme is very similar is similar to the readout described above, except instead of a camera, each cavity mode is coupled into a unique fiber and sent to the Bell State Analyzer 870.

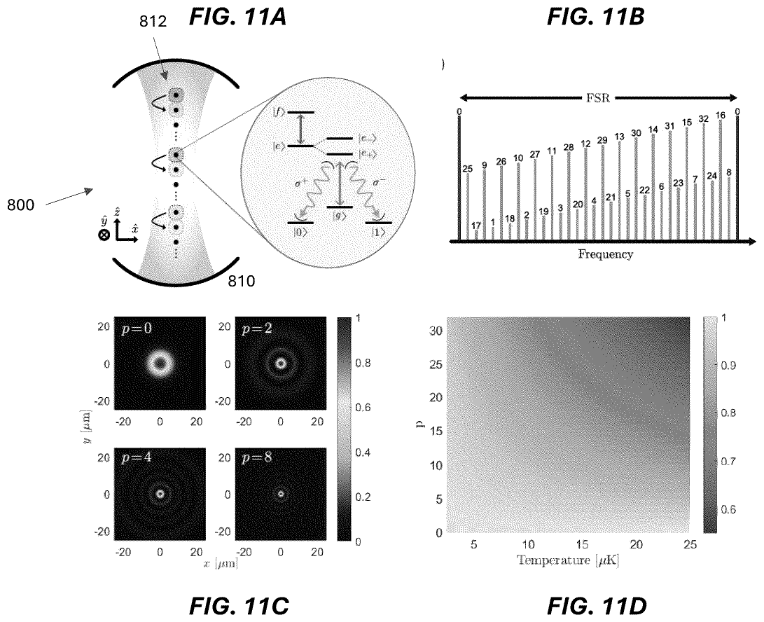

FIGS. 11A-11D illustrate a cavity and atom-array configuration for a remote entanglement module 800 using CMM with Laguerre-Gauss (LG) modes. The atoms are arranged in a 1D array with up to 255 atoms, where each atom is coupled to one of the cavity modes. Groups of consecutive atoms form registers, each associated with a distinct cavity mode and spatially separate from other registers. A control beam scans across the array, sequentially coupling atoms in each register to their assigned cavity mode following the atomic level scheme for atom—photon entanglement via vacuum-stimulated Raman adiabatic passage (vSTIRAP) at right in FIG. 11A. FIG. 11B shows equally spaced cavity resonances of 33 Laguerre-Gauss modes across a single FSR. FIG. 11C shows spatial profiles of LG modes with indices p=0, 2, 4, 8. And FIG. 11D shows the cooperativity reduction of each mode as a function of temperature.

When used with ⁸⁷Rb to implement atom-photon entanglement generation via vacuum-stimulated Raman adiabatic passage (vSTIRAP), the relevant atomic states for CMM, shown in FIG. 11A, are

$$\vert 0 〉 ≡ \vert 5 {S}_{1 / 2} , F = 1 , {m}_{F} = - 1 〉$$

$$\vert 1 〉 ≡ \vert 5 {S}_{1 / 2} , F = 1 , {m}_{F} = 1 〉$$

$$\vert g 〉 ≡ \vert 5 {S}_{1 / 2} , F = 2 , {m}_{F} = 0 〉$$

$$\vert e 〉 ≡ \vert 5 {P}_{3 / 2} , {F}^{′} = 1 , {m}_{F} = 0 〉$$

$$\vert f 〉 ≡ \vert 4 {D}_{5 / 2} , {F}^{″} = 2 , {m}_{F} = 0 〉 .$$

The atom-photon entanglement protocol proceeds as follows. The atom is first initialized in |g [symbol] . An external field then drives the |g [symbol] →|e [symbol] transition, inducing a vSTIRAP process that generates a single photon in the cavity whose polarization (σ⁺ or σ⁻) is entangled with the qubit state:

$$\vert {ψ}_{final} 〉 = \frac{1}{\sqrt{2}} ( \vert 1 , {σ}^{+} 〉 + \vert 1 , {σ}^{-} 〉 )$$

In this scheme, the probability of obtaining a photon at the cavity output is given by

$${α}_{interface} = \frac{η}{η + 1} \times \frac{{κ}_{e}}{{κ}_{e} + {κ}_{i}} ,$$

where κₑ is the cavity decay rate into the designated output mode and κᵢ is the decay rate associated with intrinsic cavity losses. An important feature of this scheme is that the external drive can be used to shape the temporal wavefunction of the emitted photon. Such control over the photon envelope is essential for ensuring the indistinguishability of photons generated across different modules, thereby enabling high-fidelity BSMs even in the presence of variations in system parameters between modules.

TABLE 3 lists parameters for a Fabry-Pérot cavity suitable for use in the remote entanglement module 800 of FIG. 11A. The total cavity linewidth includes the coupling rate to the output mode, κₑ/2π=2.3 MHz, and the internal loss rate, κᵢ/2π=38 kHz, assuming mirror losses of 10 ppm. In contrast to the case of syndrome extraction, simultaneously coupling multiple atoms to the same cavity mode offers no advantage for atom-photon entanglement. We therefore employ higher-order radial Laguerre-Gauss modes, LG_{p,0} with p ∈[0,32]. As depicted in FIG. 11C, the peak intensity of these modes at (x, y)=(0,0) remains constant with p, ensuring a mode-independent atom-cavity coupling at that location. The cavity is tuned so that these modes are equally spaced in frequency across the FSR, with 727 MHz separation between adjacent modes. Similarly to the syndrome extraction case, control beams resonant with the |e [symbol] →|f [symbol] transition dress the excited states, enabling the |0 [symbol] →|e₊ [symbol] and |1 [symbol] →|e₊ [symbol] transitions to be tuned into resonance with the desired cavity mode. A maximum frequency shift of 12 GHz with 0.1% intensity stability keeps fluctuations of the dressed-state transition within the natural linewidth, Γ/2π=6 MHz. While this tuning range does not span the full FSR, it provides access to 17 cavity modes.

TABLE 3
Parameters of the optical cavity used for modular connectivity.

| | |
|---|---|
| Cavity length | 6.25 mm |
| Mode waist | 8.6 μm |
| Rayleigh range | 0.3 mm |
| Finesse | 10⁴ |
| FSR | 24 GHz |
| Linewidth (FWHM) | 2.34 MHz |

We arrange 225 atoms in a one-dimensional array along the z-axis with a spacing of approximately 3 μm, such that the outermost atoms lie roughly one Rayleigh length from the cavity center. Individual atoms are addressed by control beams focused to a 2 μm waist. At this tight spacing, however, residual light shifts on neighboring atoms are unavoidable, compromising the selective addressing of individual atoms. For the maximum applied frequency shift of 12 GHZ, adjacent atoms experience residual shifts of approximately 1 GHz. To mitigate the crosstalk between control beams, the array is divided into registers of consecutive atoms, with each register associated with a single cavity mode. Within each register, the control beam is scanned sequentially to couple individual atoms to the appropriate mode for atom-photon entanglement. This procedure is performed in parallel across all registers, as illustrated in FIG. 11A. By increasing the spacing between simultaneously active control beams, this scheme substantially suppresses the crosstalk between the beams. Nevertheless, neighboring atoms can still experience residual light shifts that may couple them to cavity modes outside their assigned register. To prevent such unintended interactions, cavity modes with resonance frequencies within the range of the maximum residual shift are excluded from use. In practice, this constraint eliminates the two lowest-frequency modes, while the next available mode remains sufficiently detuned to suppress unwanted coupling. Consequently, a total of 15 cavity modes are available, enabling the 225-atom array to be partitioned into 15 registers of 15 atoms each.

This configuration yields an average cooperativity of η̅=7 across the array. In the calculation, we account for the branching ratios of |e₊ [symbol] to the qubit states, the variation of atom-cavity coupling along the z-axis, and an assumed atomic temperature of 10 μK. The latter affects higher-order LG modes, where the central lobe narrows with increasing p. Consequently, the finite spatial extent of the atomic wavefunction reduces the effective atom-cavity coupling, as illustrated in FIG. 11D.

With this cooperativity, it is possible to implement vSTIRAP using an external probe field resonant with the |g [symbol] →|e₊ [symbol] transition and a cavity mode tuned to the |0,1 [symbol] →|e₊ [symbol] transition. For an optical setup efficiency of αₛₑₜᵤₚ=0.75, the predicted atom-atom entanglement success probability is Pₛ=0.21. This value corresponds to the ideal case where the vSTIRAP adiabaticity condition is fully saturated and η is uniform across the array.

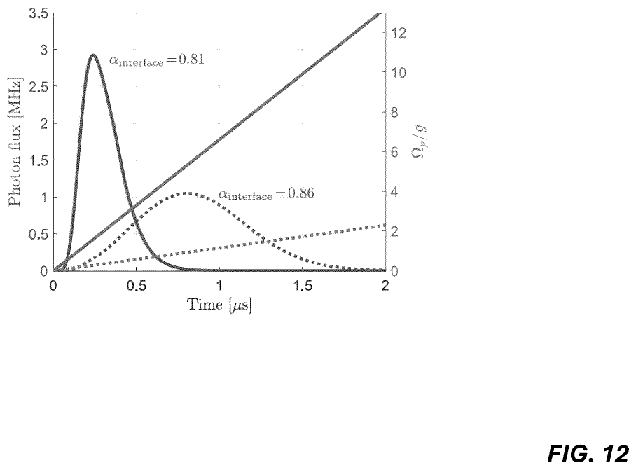

FIG. 12 shows a simulation of photon generation using vSTIRAP under realistic conditions for the entire 225-atom array, including all relevant atomic levels, using different linearly increasing drives (dotted and solid linear traces). The external probe allows control over the temporal profile of the output photon (dotted and solid curved traces). This reveals a tradeoff between photon generation probability—maximized when the adiabaticity condition is saturated (dotted traces)—and the achievable generation rate. Balancing these factors, our chosen parameters yield an average success probability of P̅ₛ=0.18 across the array. With CMM over the 15 modes, the corresponding atom-atom Bell-state generation rate is 4 MHZ.

The protocol remains robust against transition frequency fluctuations, where a 6 MHz atomic detuning leads to less than a 1% change in the atom-atom Bell-state probability. This robustness allows operation in a magnetic field, which induces Zeeman shifts to the |0 [symbol] and |1 [symbol] qubit states, and is essential for implementing high-fidelity Rydberg gates. Additional imperfections arise from spontaneous decay out of |f [symbol] into other states in the 5P_{3/2} manifold. Most such decay channels only reduce the photon collection efficiency, but decay to the |F′=1, m_{F}±1 [symbol] states can also produce a photon in the cavity while leaving the atom in |F′=1, m_{F}=0 [symbol] . This occurs with a probability of less than 1%, and can be mitigated using a measurement that discriminates between the magnetic sublevels of the F=1 manifold. Although the |e [symbol] →|f [symbol] transition is not a cycling transition, under a n polarized control beam there is no unwanted mixing with other states, since the transitions to |F″=1,3,4, m_{F}=0 [symbol] are forbidden. Under these conditions, the achievable atom-atom Bell-state fidelity is sufficient for modular architectures, since the threshold for stitching surface-code patches across modules can be as high as 10%.

To evaluate the implications for fault-tolerant architectures, we connect our results to the cycle time of a distance-20 surface code, which requires on the order of 40 teleported CNOT gates per cycle between distant code patches. In our construction, the communication atoms remain fixed in place throughout the entire process, ensuring stable coupling and minimizing the use of atom transport. The sequence of operations proceeds as follows. First, the communication qubits are initialized in |g [symbol] ; we assume that state preparation together with occasional recooling takes 16 μs, though cavity-enhanced methods could reduce this time. Next, since the expected number of successful pairs equals the number of atoms times Pₛ, the 40 Bell pairs shared between modules can be generated in a single multiplexed scan across the array. With a control-beam switching time of 100 ns, the scan completes within 12 μs. In the following step, Rydberg gates are performed between the successful communication qubits and the code qubits. This process involves qubit basis changes, transporting the code qubits, and the Rydberg interactions themselves. The dominant contribution here is the atomic motion, as Raman manipulations and Rydberg gates operate in the MHz regime. Because Rydberg operations can be carried out directly within the cavity, the surface code patch can be positioned near the cavity mode, allowing short-range transport. We estimate this step at approximately 20 μs. Finally, measurement of the 40 communication qubits is performed. With a 10 μs measurement time multiplexed over 15 modes, this takes roughly 25 μs. Adding these contributions, the full sequence of 40 teleported CNOTs completes in about 70 μs. This cycle time is roughly two orders of magnitude faster than free-space implementations, while using significantly fewer communication qubits.

### Parallel Cavity Readout Example for Longitudinal Only Cavity Modes

This section contains detailed design analysis for a longitudinal-mode-only parallelized readout. An efficient parallel cavity readout system based on longitudinal modes alone depends on various interdependent atomic and cavity parameters. We outline a comprehensive optimization approach that addresses the factors influencing the readout method, ensuring high fidelity and minimal errors across multiple atoms.

To accomplish this readout, the cavity 110 in FIGS. 1A and 1B can be a relatively long cavity (e.g., 1-5 meters) with a small free spectral range (FSR_{cav}), where adjacent longitudinal cavity modes are separated by a frequency difference of Δf₀ near the |1 [symbol] →|e [symbol] resonance. Each longitudinal cavity mode functions effectively as an independent cavity for a corresponding qubit 112. The qubits 112 are subjected to alternating current (AC) light shifts (light shift beams 121) with varying intensities on the |e [symbol] →|f [symbol] transition, tuning the excited state near resonance with a specific longitudinal cavity mode for each qubit 112. Since the light shift beams 121 are far detuned from any ground-state transitions, they minimally affect the ground-state energy levels. Subsequently, each qubit 112 is addressed by a drive (probe beam 131) with Rabi frequency Ω, differing by Δf₀ for each atom, inducing fluorescence into a distinct longitudinal cavity mode.

Seven parameters that guide the design process to implement this parallel state readout of atoms:
α: light shift stability,
Δ_{AC}: detuning of the light shift beam,
R: atomic scattering rate,
Δ: probe-atom detuning,
w_{AC}: light shift beam (1/e²) waist,
∈: cavity cooperativity variation for atoms in the cavity, and
ζ: atom-cavity photon collection efficiency.

Though these parameters are defined independently, the roles they play in the performance of the parallel readout of CMM qubits are closely interlinked. This procedure serves as a robust framework and can be adjusted to suit different experimental constraints and objectives. Additionally, as discussed below, a bow-tie cavity configuration with nondegenerate polarization modes may be utilized to effectively double the number of qubits read out without increasing the cavity length.

### Light Shifting Parameters

A first step in parameterizing the system involves setting the light shift depth for the state |e [symbol] of the atom experiencing the maximum shift, denoted as

$${U}_{A C}^{( i = N )} .$$

Each atom is assumed to be at temperature T, within a trap of depth U₀, and radial trapping frequency ω₀. The light shift of the i-th atom is given by

$${U}_{A C}^{( i )} = {ℏ ( {Ω}_{A C}^{i} )}^{2} / 4 {Δ}_{A C} ,$$

where

$${Ω}_{A C}^{i}$$

is the Rabi frequency Δ_{AC} is the detuning of the light shift beam.

Fluctuations in

$${U}_{A C}^{( i )}$$

can affect the readout parameters, particularly by altering the scattering rate in Eq. (1). These fluctuations should remain small compared to the mean value of Δ, the probe-atom detuning, to minimize changes in the scattering and heating rates. α is the stability criterion, which quantifies the allowable fluctuation range in Hz for

$${U}_{A C}^{( i = N )} .$$

Additionally, the detuning Δ_{AC} should be large enough to ensure that any wavelength variations do not significantly affect the trap depth.

### Atomic Parameters

The atomic parameters—namely, the light shift beam waist w_{AC}, probe-atom detuning Δ, and atomic scattering rate R—affect readout speed and errors. Traditional cavity readout errors stem from depumping, poor coupling during imaging, and dipole force fluctuations. In CMM, there is no depumping if the polarization is purely σ⁺; however, if there is some π or σ⁻ component, there may be depumping out of the cycling transition. This depumping can be mitigated through implementation of an offset light shift for the atoms, such that

$${U}_{A C}^{( i = 1 )} \neq 0 ,$$

since other levels will be shifted away through the vector light shift, thereby reducing the rate of depumping. With pure polarization, no depumping, and

$${U}_{A C}^{( i = 1 )} = 0 ,$$

the first atom excited state |e [symbol] should remain unshifted.

The second source of infidelity, low cavity coupling due to transitions with a small Clebsch-Gordan coefficient, is additionally not a concern since the system remains in the same state on a closed cycling transition. However, there is potentially a much larger infidelity contribution than in other work from dipole force fluctuations on the i'th atom due to the large excited-state potential to make it resonant with the longitudinal cavity modes, given by:

$${H}^{( i )} = \frac{{ℏ}^{2} {Ω}^{4}}{8 m Γ {Δ}^{4}} {( ∇ ( {U}_{0}^{( i )} - {U}_{A C}^{( i )} ) )}^{2} \approx \frac{{ℏ}^{2} {{Ω}^{4} ( ∇ {U}_{A C}^{( i )} )}^{2}}{8 m Γ {Δ}^{4}} \qquad ( 2 )$$

where we neglect the small contributions from heating on the |e [symbol] →|f [symbol] transition of order

$${ρ}_{e e}^{4} .$$

We consider the effects of heating, crosstalk, and readout time in setting w_{AC}, Δ, and R. The probe-atom detuning Δ affects both atomic crosstalk and scattering rates for a given fluorescence drive Rabi frequency Ω. Larger Δ reduces sensitivity to fluctuations from the light shifting beam and reduces heating from dipole force fluctuations. However, larger detuning exacerbates crosstalk between adjacent atoms in the cavity since Ω² should increase proportionally to maintain the same scattering rate for each atom. Relatedly, a high scattering rate decreases the readout time for the atomic state but increases the heating rate for the i'th atom H⁽ⁱ⁾ from dipole force fluctuations and incoherent scattering. Per Eq. (2), the heating rate is proportional to the square of the gradient of the induced potential and can be reduced by increasing the waist of the beams. For the present case,

$$∇ {U}_{A C}^{i} ≫ ∇ {U}_{0}^{i} ,$$

so

$${H}^{( i )} ∝ 1 / {w}_{A C}^{4} ,$$

where w_{AC} is the 1/e² waist of the Gaussian light shift beam. The parameters Δ, R, and w_{AC} interact in setting the heating rate, scattering rate, and cross talk between atoms.

After setting the maximum shift (by choosing parameter α), the detuning for the light shift beam (parameter Δ_{AC}), and the waist of the light shift beam (parameter w_{AC}), the total power

$${P}_{0}^{( i = N )}$$

for the atom with the maximum light shift can be calculated.

$${P}_{0}^{( i = N )}$$

is extracted from the maximum detuning and maximum light shift using the equations for the Rabi frequency

$${Ω}_{A C} = ( {d}_{A C} / ℏ ) \sqrt{2 {P}_{0}^{i = N} / c {ε}_{0} π {w}_{A C}^{2}} ,$$

where d_{AC} is the dipole matrix element, w_{AC} is the light shift beam waist, and from the Stark shift equation above. The total power is then given by

$${P}_{tot} = {\sum }_{i = 1}^{N} [ {P}^{( i = N )} \cdot ( i - 1 ) ] / ( N - 1 ) = {P}^{( i = N )} N / 2.$$

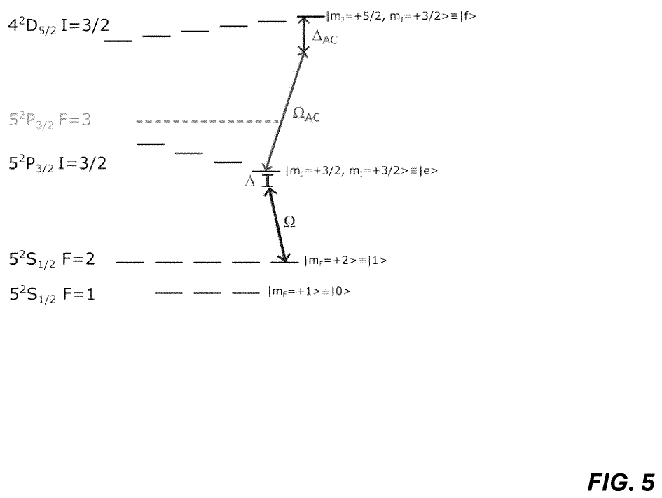

FIG. 5 shows the level structure of an ⁸⁷Rb atom used for CMM, parallel readout. The computational levels of the qubit are |0 [symbol] =|F=1, m_{F}=1 [symbol] and |1 [symbol] =|F=2, m_{F}=2 [symbol] . The imaging transition 5S_{1/2}→5P_{3/2}=|e [symbol] is used to read out the state of the atom via cavity fluorescence collection, and state |f [symbol] is used to light shift |e [symbol] into near resonance with the corresponding longitudinal cavity mode. The cavity is tuned to the same frequency as the detuned fluorescent light. For the states |e [symbol] and |f [symbol] , the shifts are larger than their corresponding hyperfine structure and the appropriate quantum numbers are |I, J, mⱼ, mᵢ) where I is the total nuclear spin, J is the total orbital angular momentum, m_{J} and m_{I} are their respective z-axis projections. The stretched states |I, J, F, m_{F}=F [symbol] and |I, J, F, m_{J}=J, m_{I}=I [symbol] , where F is the total angular momentum and m_{F} is its z-projection, are identical in both bases. There is no excitation to any state except the stretched states to prevent the atom from becoming dark to the fluorescence (probe) beam.

### Cavity Parameters

We now proceed to determine the cavity parameters for maintaining uniform coupling across the atomic array and achieving high photon collection efficiency for each atom, as described by Eq. (1). Generally, the cavity can have a free spectral range of 10 MHz to 1 GHZ (e.g., 100, 200, 300, 400, or 500 MHZ), a finesse of 1,000-100,000 (e.g., 3,000 or 4,000), and a length of tens of centimeters to meters (e.g., about 1 m), and can hold 2-1000 qubits (e.g., 50, 100, 250, or 500 qubits).

The selection of the cavity length L and the free spectral range (FSR_{cav}) is dictated by the number of atoms to be read out in parallel and the light shift of the atom experiencing the maximum shift,

$${U}_{A C}^{( i = N )} .$$

### Specifically,

$${FSR}_{cav} = c / L = ( {U}_{AC}^{( i = N )} / h ) ( 1 + 1 / N ) ,$$

where L is the round-trip length of the cavity. Achieving a small FSR necessitates a cavity with large spatial dimensions, corresponding to a long round-trip length L.

The cavity waist w_{cav} affects the variation in cooperativity η across the atom array. A larger w_{cav} generally reduces the variation in cooperativity, but also leads to a higher cavity finesse [symbol] for the same η, as the cooperativity scales with

$$η ∝ ℱ / {w}_{cav}^{2} .$$

To ensure that the cooperativity remains above a threshold ∈η throughout the qubit array, where Ns represents the total spatial extent of the array, the qubits are arranged in a linear chain within the cavity. Once w_{cav} is determined, the cavity finesse [symbol] is adjusted to increase the collection efficiency ζ for the atom with the lowest cooperativity at the chain's end, since a smaller waist implies a smaller Rayleigh length. This adjustment affects both the cavity linewidth κ and the vacuum Rabi frequency 2 g, thereby setting the cooperativity.

Selecting these parameters methodically enables fast, parallel readout of multiple CMM atoms within the cavity, ensuring both high fidelity and efficiency.

### Example CMM System Design

TABLE 1
Example choices for parameters α, Δ_{AC}, w_{AC}, R, Δ, ϵ, ζ
and the resulting system values.

| Parameter | Value | |
|---|---|---|
| Light Shift Stability α | 1.00 | Γ |
| Light Shift Detuning Δ_{AC} | 1.00 × 10⁴ Γ | |
| Probe-Atom Detuning Δ | −10.0 | Γ |
| Scattering Rate R | 2 × 10⁶ s⁻¹ | |
| Light Shift Waist w_{AC} | 3.53 | μm |
| Cooperativity Variation ϵ | 0.900 | |
| Cavity Collection Efficiency ζ | 0.667 | |
| Light Shift Rabi Ω_{AC} | 2π × 38.3 GHz | |
| $Power for N ’ th Light Shift {P}_{0}^{( i = N )}$ | 12.4 | mW |
| Total Light Shift Power Pₜₒₜ | 186 | mW |
| $Light shift for N ’ th Atom {U}_{AC}^{( i = N )} / h$ | −6.07 | GHz |
| Single Photon Vacuum Rabi g | 2π × 677 kHz | |
| Cavity Linewidth κ | 2π × 136 kHz | |
| Cavity Round Trip Length | 74.1 | cm |
| Cavity Waist | 6.28 | μm |
| Cavity Finesse [symbol] | 2980 | |
| Cavity Free Spectral Range FSR_{cav} | 404.4 | MHz |

TABLE 1 gives a set of physically realizable parameters that can be used to implement the simultaneous, parallel readout of qubits in a cavity with CMM. Many other configurations are possible and fall within the scope of the present technology. More specifically, TABLE 1 gives system parameters for the simultaneous readout of a total of 30 ⁸⁷Rb atoms in 24 μs. The qubit levels (for state detection), depicted in FIG. 5, are encoded in the 5S_{1/2} hyperfine manifold where |0 [symbol] =|F=1, m_{F}=1 [symbol] and |1 [symbol] =|F=2, m_{F}=2 [symbol] . The other two relevant states are the |F=3, m_{F}=3 [symbol] |e [symbol] level in the 5P_{3/2} manifold (Γ=2π×6.07 MHZ) used for imaging and the light shift level 4D_{5/2}=|f [symbol] . The light shifting beams (λ_{AC}=1530 nm) operate at detunings large enough so that the fine structure in the 4D manifold, separated by about 13.4 GHz, is not resolved. The cavity holds N=15 atoms, where each atom is individually addressed by both a light shift beam and a fluorescence beam with an intensity and frequency selected to drive fluorescence into the cavity. Using a bow-tic cavity with nondegenerate polarization modes doubles the read-out atom number from 15 to 30 with the same parameters except at the cost of a factor of two in cooperativity and minor additional complexities as explained below.

### Light Shifts

For the light shift stability of each trap, a, we impose a shift stability for the maximally shifted atom of 1.00×Γ. If the laser has a fractional power stability of 1.00×10⁻³, the light shift for the atom in the array with the largest light shift,

$${U}_{A C}^{( i = N )}$$

is then 1.00×10³Γ=6.07 GHz. For the light shift detuning, Δ_{AC}, a value of Δ_{AC}=1.00×10⁴Γ=2π×60.7 GHz is large enough so that any frequency variations with time on the order of 60.7 MHz contribute to trap depth variations at the level of 10⁻³ and the linewidth for typical distributed Bragg reflector (DBR) or distributed feedback (DFB) lasers, on the order of MHz, can be neglected. For w_{AC}=3.53 μm (see next section), the total power of the light shift beam is Pₜₒₜ=2×186 mW=372 mW and that the power for the maximally shifted atom in the array is 12.4 mW.

In implementing the light shift, we use circularly polarized σ⁺1530 nm light since the 5S_{1/2}→5P_{3/2}=|e [symbol] transition wavelength is different for every m_{F} level as shown in FIG. 5, and a decay during readout to a state other than |F=2, m_{F}=2 [symbol] may send the qubit to a state dark to the fluorescence light. Both light sources should be σ⁺ polarized to maintain the qubit on the cycling transition. Using the parameters above for the light shift, the ground state is minimally affected, with a shift of 0.927 MHz and a scattering rate of 0.186 photons/s.

### Atomic Fluorescence

Next, we determine the atomic scattering parameters. Choosing R, Δ, and w_{AC} is a tradeoff between crosstalk between qubits, heating rates, and stability of the scattering rate due to power fluctuations. To enable a fast readout rate, we set R=2×10⁶ photons/s. We next set Δ=−10Γ, which maintains the scattering rate R to within 23% assuming a stability of α=Γ. We set the worst-case scenario heating rate (for the qubit with the maximum light shift) to be H^{(i=N)}=100 kHz/100 μs, which finally allows us to determine w_{AC}=3.53 μm at the root-mean-square atomic position

$${x}_{rms} = \sqrt{{k}_{B} T / ( m {ω}_{0}^{2} )} .$$

we set the atom separation in the linear array to be s=w_{AC}.

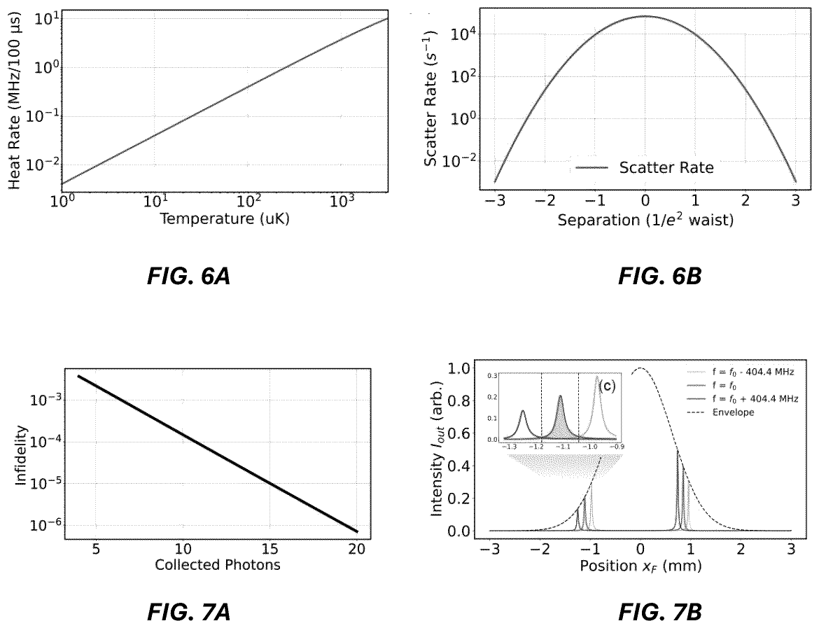

FIGS. 6A and 6B show the heating rate as a function of atomic temperature and the crosstalk as a function of fluorescence beam waist, respectively. In FIG. 6A, the qubit is in a 20 MHz and 1 μm trap, and the largest contribution comes from the gradient of the excited state potential. Heating is proportional to

$${ρ}_{ee}^{2}$$

and can be reduced for the same total number of photons scattered by detuning the fluorescence light further. In FIG. 6B, the scattering rate is R=2.00×10⁶ for the targeted atom and neighboring adjacent atoms are 10Γ+404 MHz detuned from the target.

### Cavity Design: Bow-Tie Cavities

There are many choices of cavities and cavity parameters. The cavity should have a high collection efficiency, fast readout, large atom number, high stability, and minimal cross talk between qubits. A bow-tie cavity satisfies these criteria. There are many advantages of using a bow-tie cavity over a two-mirror cavity for this application. First, the large mirror separation reduces or avoids deleterious effects on Rydberg states. Additionally, bow-tie cavities can achieve small waists with high stability, obtain cooperativities that are independent of qubit positioning in the cavity due to the running wave modes, and have a naturally emerging nondegeneracy in polarization modes that proves useful in scaling to larger numbers of qubits without lengthening the cavity.

The cavity used for the experiments presented here was designed to ensure that the lowest cooperativity experienced by any of the atoms over the ±52.9 μm range did not vary greatly by setting ∈=0.900, which gave a cavity waist of w_{cav}=6.28 μm. The minimum fraction of light scattered into the cavity for the atom with the smallest cooperativity at the end of the chain, ζ, was chosen to be 0.667. These led to cavity parameters (g, κ, Γ)=2π×(677,136,6070) kHz, a cavity ringdown time τ=1.17 μs, and modest finesse [symbol] =2πc/Lκ=2980. The cooperativity of a single transverse mode for an edge qubit at the end of the chain is

$${η}_{1}^{( i = N )} = 2 {( {g}^{( i = N )} )}^{2} / κΓ = 2 .$$

The total cooperativity is given by the sum of the two running wave modes η^{(i=N)}=4(g^{(i=N)})²/κΓ=4. Over the full range of the cavity mode experienced by the qubits, the cavity cooperativity stays larger than 90% of its maximal value.

Bow-tic cavities can have a naturally emerging nondegeneracy of left- and right-handed circularly polarized mode character when the mode is aligned at an angle out of the plane of the cavity (a twist). This twist rotates the polarization by a small amount after each round trip, and over many round trips can accumulate a large phase difference between modes, which can be on the order of hundreds of cavity linewidths. Choosing a cavity mirror configuration with a large twist induces a large splitting between right- and left-hand circularly polarized light. This effectively doubles the number of available cavity modes without further lengthening the cavity but comes at the cost of a 50% reduction in cooperativity from the lowered cavity coupling. The photons collected from the cavity can be separated out by polarization, which enables the splitting of frequencies that may otherwise be too close together to spatially resolve. This doubles the cavity's atom number from N=15 to 30 without lengthening the cavity through the introduction of a second class of atom qubits that have the same parameters as the first, except for being resonant with the second cavity longitudinal polarization mode. By coupling the atoms to nondegenerate modes and thereby reducing η^{(i=N)} by a factor of 2, a collection efficiency of 66.7% is achieved assuming no intra-cavity losses.

### Mode Sorter/Diffractive Element Design

An optical element such as a highly-dispersive VIPA separates the photons of different frequencies in overlapped cavity modes. VIPAs spatially separate the different frequency components in the TEM₀₀ mode exiting the cavity with a frequency resolution of over 1×10⁶. By partially coating an entrance window into the VIPA and using a cylindrical lens to focus the light into a transmissive strip, the VIPA can transmit nearly 100% of the input beam into multiple diffracted orders. A Gaussian beam of waist w₀ incident into a VIPA at an angle θᵢ, focused down by a cylindrical lens of focal length f, and collimated by a focal length F is given by

$${I}_{out} ( x , λ ) ∝ exp ( - \frac{2 {f}^{2} {x}^{2}}{{F}^{2} {w}_{0}^{2}} ) \times \frac{1}{{( 1 - R r )}^{2} + 4 {( R r )}^{2} {sin}^{2} ( \frac{k ϕ}{2} )} ,$$

$$where$$

$$ϕ = 2 t cos ( {θ}_{i} ) - ( \frac{( 2 t sin ( {θ}_{i} ) {x}_{F} )}{F} ) - ( \frac{( t cos ( {θ}_{i} ) {x}_{F}^{2} )}{{F}^{2}} ) ,$$

x is the measurement position in meters from the optical axis, and t is the VIPA thickness. The transmission spectrum of a VIPA is characteristic of an exponentially decaying envelope with narrow Lorentzian peaks at kφ/2=mπ with widths obtained by expanding the denominator as a Taylor series around these points.

An example VIPA may have a modest finesse, e.g., 72 (R×r=0.957). The VIPA's FSR, FSR_{VIPA}, should encompass all shifted longitudinal mode resonances of atoms, FSR_{VIPA}=(N+1) FSR_{cav}. For our parameters, FSR_{VIPA}=6.47 GHz corresponds to a VIPA thickness of about 23.2 mm. The VIPA finesse, determined largely by surface roughness, determines the final readout speed and fidelity in conjuction with the atomic scattering rate R. These parameters provide a spectral resolution of roughly 87 MHz at 780 nm. We assume an incidence angle of θᵢ=0.5 degrees and an incident w₀=1/e² beam radius of 0.25 mm focused by a 200 mm cylindrical lens. The final output lens F can be adjusted to match a camera or fiber array. A sample output for three different frequencies at 780 nm separated by 404.4 MHZ, the separation between adjacent longitudinal cavity modes, is shown in FIGS. 7A and 7B with F=1000 mm. The spatially separated photons can then be imaged on as camera as described below.

FIG. 7A is a plot of readout fidelity as a function of collection photon number for the VIPA parameters specified above. FIG. 7B shows the VIPA profile as a function of camera position along the transverse dimension, x. For this choice of parameters, almost all the intensity is contained within two peaks. The inset of FIG. 7B is a close-up view of the atomic spectra. Colored in red is the area between adjacent atom spectra for a central atom. The area under the curve determines the fidelity and speed of readout.

It is possible to use a VIPA for fine resolution in conjunction with a diffraction grating for coarser resolution in a crossed-dispersed configuration. Using a cross-dispersed setup, which utilizes a diffraction grating after the VIPA to separate out frequencies along an axis orthogonal to a VIPA, enables read out of frequencies separated by much larger than the VIPA FSR, and scaling to even larger numbers of atoms.

### Fidelities

For cavity readout, each atom emits a different frequency into the same spatial mode. A VIPA or other optical element separates these components into many different diffracted orders. Imaging these different modes onto a one-dimensional line on a camera or detector array yields a spectrograph. Instead of imaging just the first diffracted order, however, imaging multiple diffracted orders enhances the readout SNR. This technique should be limited only by the readout noise of the camera in use (electron-multiplying charge-coupled devices (EMCCDs) can have noise <0.1 e⁻ at high gains) and effectively makes the out-of-cavity to camera efficiency 100%. In the following, we imaged two peaks which enclose at least 99% of the total photons for all frequencies within a VIPA FSR.

The spectrum of light passing through the VIPA is approximately Lorentzian along the x direction. Along the y direction, the beam has been either numerically integrated out or physically focused down to a size much smaller than the camera pixel. FIG. 7A shows infidelity for readout, calculated by summing the number of photons between the intersection of adjacent spectra of light emitted by atoms. Numerically varying the center wavelength to find the minimum the area enclosed between the intersection of adjacent curves gives a lower bound on the estimate for the fidelity of readout. For the parameters specified above, 87.3% of the spectrum area is enclosed in the worst-case scenario for the chosen parameters above. FIG. 7A shows that this corresponds to collection of 12 photons for an error of 10⁻⁴.

Utilizing the scattering rate of R=2×106 photons/s for each atom in the cavity and assuming a photonic loss rate of 75% due to cavity coupling, VIPA coupling, cavity cooperativity, fiber coupling, and camera loss gives a readout time of 24 μs with an infidelity of about 10⁻⁴ for about 48 scattered photons.

To further improve the readout fidelity and speed, the photons generated by the atoms could be mapped to many pixels and weighted based on where they are collected on the sensor. Adapting machine learning schemes could further enhance the readout fidelity.

### Heating Rate

Here, we derive the heating rate in Equation (2) for an atom addressed by a beam of Rabi frequency Ω and detuning Δ. The atom is in a potential defined by U_{g} for the ground state and Uₑ is the excited state. We begin with the equation for the momentum diffusion coefficient D

$$D = {\int }_{0}^{∞} d t [ 〈 F ( t ) \cdot F ( t + τ ) 〉 - {f}^{2} ] ,$$

where F is the force experience by an atom at time t, τ is the excited state lifetime, and f is the mean force experienced. For a two-level system with levels |g [symbol] and |e [symbol] , the correlation can be written as

$$〈 F ( t ) \cdot F ( t + τ ) 〉 = {\sum }_{m = g , e} {\sum }_{n = g , e} ( - ∇ {U}_{m} ) ( - ∇ {U}_{n} ) P ( m , t ; n , t + τ ) ,$$

where P(m, t; n, t+τ) is the probability to be in state m at time t and n at time t+τ. It can be shown that

$$D = \frac{{ρ}_{ee} {ρ}_{gg}}{Γ ( {sin}^{4} θ + {cos}^{4} θ )} ( {( ∇ {U}_{g} - ∇ {U}_{e} )}^{2} ) ,$$

where θ is defined by cos 2θ=Δ/\sqrt{Ω²+Δ²} and sin 2θ=Ω/\sqrt{Ω²+Δ²}, ρₑₑ is the excited state population, and ρ_{gg} is ground state populations.

The heating rate H is connected to the momentum diffusion equation via d [symbol] /dt=( [symbol] /dt)/2 m and finally we can write

$$H = \frac{{ℏ}^{2} {Ω}^{4}}{8 m {ΓΔ}^{4}} {( ∇ {U}_{g} - ∇ {U}_{e} )}^{2} .$$

### Parallel Readout of Alkaline Earth Atoms

This scheme also works for qubits with readily accessible metastable states, such as alkaline-earth atoms, without light shifting levels as shown in FIG. 1A. In contrast to alkali atoms, where the frequency separation between qubit states is relatively small and there are no readily available protected metastable states for shelving one qubit state during the readout of the other, the level structure of alkaline-earth atoms allows shelving of one qubit state in a metastable level far detuned from the readout transition. This enables each alkaline-earth atom to be individually targeted by fluorescence beams of different detunings and intensities without leading to deleterious effects, e.g., depumping to the wrong qubit state. Like the alkali case, the frequencies of the detuned beams match the corresponding illuminated atom's longitudinal cavity mode and the power for each beam is such that the scattering rate is constant for every qubit. In summary, this does not involve shifting the atomic level structure with a light shift beam but instead has each qubit scatter into the cavity in a variable off-resonant process.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein.

The foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A quantum processor comprising:
a cavity supporting a plurality of cavity modes;
an array of qubits trapped in the cavity, such that different qubits in the array of qubits are configured to emit photons into different cavity modes in the plurality of cavity modes;
a cavity mode separator, in optical communication with the cavity, to map the different cavity modes to distinct spatial channels; and
a detector array, in optical communication with the cavity mode separator, to detect the photons in the distinct spatial channels.

2. The quantum processor of claim 1, wherein the plurality of cavity modes comprises longitudinal cavity modes and/or transverse cavity modes.

3. The quantum processor of claim 1, wherein the array of qubits comprises neutral atoms.

4. The quantum processor of claim 1, wherein the array of qubits comprises ions.

5. The quantum processor of claim 1, wherein the array of qubits comprises a first register of qubits coupled to a first cavity mode of the plurality of cavity modes and a second register of qubits coupled to a second cavity mode of the plurality of cavity modes.

6. The quantum processor of claim 5, wherein the second register is spatially separated from the first register.

7. The quantum processor of claim 1, wherein the cavity mode separator comprises at least one of a virtually imaged phased array (VIPA), a multi-plane light converter (MPLC), or a diffractive element.

8. The quantum processor of claim 1, further comprising:
at least one first laser, in optical communication with the array of qubits, to tune the different qubits to be resonant or near-resonant with the different cavity modes; and
at least one second laser, in optical communication with the array of qubits, to couple the array of qubits to the cavity.

9. The quantum processor of claim 8, wherein the array of qubits comprises a first qubit with a ground state |g [symbol] , an excited state |e [symbol] , and a higher-lying excited state |f [symbol] , and the at least one first laser illuminates the first qubit with a control beam resonant or near-resonant with a transition from the excited state |e [symbol] to the higher-lying excited state |f [symbol] .

10. The quantum processor of claim 9, wherein the at least one second laser is configured to illuminate the first qubit with a probe beam that couples the first qubit to the cavity via an optical transition between the excited state |e [symbol] and the ground state |g [symbol] .

11. A method of optically extracting qubit states of qubits trapped in a cavity supporting a plurality of cavity modes, the method comprising:
coupling photons from different qubits into different cavity modes of the plurality of cavity modes;
coupling the photons out of the cavity;
separating the photons as a function of cavity mode; and
detecting the photons.

12. The method of claim 11, wherein the different cavity modes comprise longitudinal cavity modes and/or transverse cavity modes.

13. The method of claim 11, wherein the qubits comprise neutral atoms.

14. The method of claim 11, wherein the qubits comprise ions.

15. The method of claim 11, wherein the different qubits are syndrome qubits and optically extracting the qubit states is part of a search for syndrome qubits in an undesired qubit state, the undesired qubit state indicating an error in a quantum computation.

16. The method of claim 11, wherein the different qubits comprise a first register of qubits coupled to a first one of the different cavity modes and a second register of qubits coupled to a second one of the different cavity modes.

17. The method of claim 16, wherein the second register is spatially separated from the first register.

18. The method of claim 11, wherein the cavity is a first cavity and detecting the photons comprises:
interfering the photons with photons emitted by different qubits in a second cavity to generate Bell pairs and thus distribute entanglement between the different qubits in the first cavity and the different qubits in the second cavity.

19. The method of claim 11, further comprising:
tuning the different qubits to be resonant or near-resonant with the different cavity modes with one or more control beams.

20. The method of claim 19, wherein each qubit has a ground state |g [symbol] , an excited state |e [symbol] , and a higher-lying excited state |f [symbol] , tuning each qubit to be resonant or near-resonant with a corresponding mode of the cavity comprises coupling the excited state |e [symbol] to the higher-lying excited state |f [symbol] with a corresponding one of the one or more control beams, and coupling the photons from the different qubits into the different cavity modes comprises driving each qubit to transition between the excited state |e [symbol] and the ground state |g [symbol] with a corresponding probe beam.
